(19) United States
(12) Patent Application Publication
(10) Pub. No.: US 2025/0131563 A1
(43) Pub. Date: Apr. 24, 2025

(54) ADAPTIVE LEARNING FRAMEWORK FOR DIGITAL PATHOLOGY

(71) Applicant: Ventana Medical Systems, Inc., Tucson, AZ (US)

(72) Inventors: Qinle Ba, San Mateo, CA (US); Ipshita Bhattacharya, San Jose, CA (US); Christoph Guetter, Alameda, CA (US); Veena Kaustaban, Sunnyvale, CA (US); Jim F. Martin, Mountain View, CA (US); Nahill Atef Sobh, Urbana, IL (US); Mohammad Saleh Miri, San Jose, CA (US); Satarupa Mukherjee, Fremont, CA (US)

(73) Assignee: Ventana Medical Systems, Inc., Tucson, AZ (US)

(21) Appl. No.: 18/976,550

(22) Filed: Dec. 11, 2024

Related U.S. Application Data
(63) Continuation of application No. PCT/US2023/026000, filed on Jun. 22, 2023.
(60) Provisional application No. 63/366,871, filed on Jun. 23, 2022.

(51) Int. Cl. G06T 7/00; G06N 3/0985; G06V 10/25; G06V 10/764

(52) U.S. Cl. CPC G06T 7/0012; G06N 3/0985; G06V 10/25; G06V 10/764; G06T 2207/20081; G06T 2207/20084

(57) ABSTRACT

The present disclosure relates to techniques for efficient development of initial models and efficient model update and/or adaptation to a different image domain using an adaptive learning framework. For efficient development of initial models, a two-step development strategy may be performed as follows: Phase 1: Model preconditioning, where an artificial intelligence system leverages existing annotated datasets and improves learning skills through training of these datasets; and Phase 2: Target-model training, where an artificial intelligence system utilizes the learning skills learned from Phase 1 to extend itself to a different image domain (target domain) with less number of annotations required in the target domain than conventional learning methods. To efficiently perform model update and adaptation to new datasets after initial model development, a digital pathology scenario is identified, an adaptive-learning method is selected based on the scenario, and the model is updated and adapted to new datasets using the adaptive-learning method.

### CROSS-REFERENCE TO RELATED APPLICATIONS

This application is a continuation of International Application No. PCT/US2023/026000, filed on Jun. 22, 2023, which claims the benefit of and priority to U.S. Provisional Application No. 63/366,871, filed on Jun. 23, 2022, each of which are hereby incorporated by reference herein in their entireties for all purposes.

### FIELD

The present disclosure relates to digital pathology, and in particular to techniques for efficient development of initial models and efficient model update and/or adaptation to a different image domain using an adaptive learning framework.

### BACKGROUND

Digital pathology involves scanning of slides (e.g., histopathology or cytopathology glass slides) into digital images interpretable on a computer screen. The tissue and/or cells within the digital images may be subsequently examined by digital pathology image analysis and/or interpreted by a pathologist for a variety of reasons including diagnosis of disease, assessment of a response to therapy, and the development of pharmacological agents to fight disease. In order to examine the tissue and/or cells (which are virtually transparent) within the digital images, the pathology slides may be prepared using various stain assays (e.g., immunohistochemistry) that bind selectively to tissue and/or cellular components. Immunofluorescence (IF) is a technique for analyzing assays that bind fluorescent dyes to antigens. Multiple assays responding to various wavelengths may be utilized on the same slides. These multiplexed IF slides enable the understanding of the complexity and heterogeneity of the immune context of tumor microenvironments and the potential influence on a tumor's response to immunotherapies. In some assays, the target antigen in the tissue to a stain may be referred to as a biomarker. Thereafter, digital pathology image analysis can be performed on digital images of the stained tissue and/or cells to identify and quantify staining for antigens (e.g., biomarkers indicative of various cells such as tumor cells) in biological tissues.

Artificial intelligence and machine learning based approaches and/or techniques have shown great promise in digital pathology image analysis, such as in cell detection, counting, localization, classification, and patient prognosis. Many computing systems provisioned with machine learning techniques, including convolutional neural networks (CNNs), have been proposed for image classification and digital pathology image analysis, such as cell detection and classification. For example, CNNs can have a series of convolution layers as the hidden layers and this network structure enables the extraction of representational features for object/image classification and digital pathology image analysis. In addition to object/image classification, machine learning techniques have also been implemented for image segmentation. Image segmentation is the process of partitioning a digital image into multiple segments (sets of pixels, also known as image objects). The goal of segmentation is to simplify and/or change the representation of an image into something that is more meaningful and easier to analyze. For example, image segmentation is typically used to locate objects such as cells and boundaries (lines, curves, etc.) in images. To perform image segmentation for large data (e.g., whole slide pathology images), the image is first divided into many small patches. A computing system provisioned with machine learning techniques is trained to classify each pixel in these patches, all pixels in a same class are combined into one segmented area in each patch, and all the segmented patches are then combined into one segmented image (e.g., segmented whole-slide pathology image). Thereafter, machine learning techniques may be further implemented to predict or further classify the segmented area (e.g., positive cells for a given biomarker, negative cells for a given biomarker, or cells that have no stain expression) based on representational features associated with the segmented area.

### SUMMARY

Artificial intelligence and machine learning based approaches have achieved superior performance in digital pathology. However, developing such models is extremely time-consuming and resource intensive. Not only hundreds of thousands of annotations are required to build a reliable model from scratch in the initial development phase, but once developed, the models are limited in their generalizability to unseen data, which leads to the inevitable continuous investment of developing new models even for related tasks. Disclosed herein is a framework to reduce resource demand in the entire development process for AI-based digital pathology algorithms, including the initial model development and subsequent model update, improvement, and adaptation to different datasets. Specifically, disclosed herein is a model preconditioning phase with existing annotated datasets, related but not necessarily similar to the target dataset to build models on, so that in the initial model development only a small number of annotations are required to generate a model with reasonable accuracy. For the subsequent model update and adaptation stages, adaptive learning workflows are used for multiple digital pathology scenarios and strategies to select the best learning method for efficient model update without the need to train all the data from scratch.

In various embodiments, a computer-implemented method is provided that comprises: obtaining, at a data processing system, a first annotated training set of images for training a machine learning algorithm to detect, characterize, classify, or a combination thereof some or all regions or objects within the images, where the first annotated training set of images are in a first image domain; splitting, by the data processing system, the first annotated training set of images into mini-sets of images each mini-set representing a distinct modeling subtask and comprising a limited number of examples; training, by the data processing system, the machine learning algorithm in a first phase using the mini-sets of images to generate a preconditioned machine learning model configured to detect, characterize, classify, or a combination thereof some or all regions or objects within new images; label, by the data processing system, a limited number of images from a target dataset to generate a second annotated training set of images for training a machine learning algorithm to detect, characterize, classify, or a combination thereof some or all regions or objects within the images, where the second annotated training set of images are in a second image domain; and training, by the data processing system, the preconditioned machine learning model in a second phase using the second annotated training set of images to generate a target machine learning model configured to detect, characterize, classify, or a combination thereof some or all regions or objects within the new images, where a number of classes being trained on in the first phase are a part of or match the number of classes being trained on in the second phase.

In some embodiments, the first annotated training set of images are digital pathology images comprising one or more types of cells.

In some embodiments, the splitting comprises: when only one mini-set of images is available, for each distinct modeling subtask, select a subset of classes to be a part of or match the number of classes being trained on in the second phase and select the limited number of examples based on the selected subset of classes; and when multiple mini-sets of images are available, for each distinct modeling subtask, either: (i) mix examples from the multiple mini-set of images, select a subset of classes to be a part of or match the number of classes being trained on in the second phase, and select the limited number of examples from the mixed examples based on the selected subset of classes, or (ii) select a mini-set of images from the multiple mini-set of images, select a subset of classes to be a part of or match the number of classes being trained on in the second phase, and select the limited number of examples from the selected mini-set of images based on the selected subset of classes.

In some embodiments, the second phase further comprises: applying the preconditioned machine learning model to generate a feature vector representation for each example within the second annotated training set of images; combining the feature vector representations from examples of a same class to generate one representation per target class, use one representation per target class as prototypes for target classes; generating feature vector representations for images or image regions of a remainder of unlabeled images from the target dataset; and comparing each feature vector representation from the unlabeled images with the prototypes for target classes based on a distance between the feature vector representation from the unlabeled images and the prototypes for target classes.

In some embodiments, the first phase further comprises: an inner learning-loop, where the machine learning algorithm updates model weights or parameters on one subtask with a predefined or flexible number of epochs for initializing the preconditioned machine learning model for adaption to the target dataset, which generates a loss for a validation set of images after model update, denoted as L-subtask-i for the ith-subtask; and an outer learning-loop, where an objective is to search for a set of model initializations that generates the preconditioned machine learning model when used for updating all subtasks, each with only the limited number of examples, by finding a model initialization that minimizes a sum of all loss, denoted as summing up L-subtask-i, with i ranging from 1 to a number of subtasks calculated from validation sets of images of the subtasks with respect to the model initialization.

In some embodiments, the training of the first phase comprises performing iterative operations to learn a set of parameters to detect, characterize, classify, or a combination thereof some or all regions or objects within the mini-sets of images that maximizes or minimizes a cost function, where each iteration involves finding the set of parameters for the machine learning algorithm so that a value of the cost function using the set of parameters is larger or smaller than a value of the cost function using another set of parameters in a previous iteration, and where the cost function is constructed to measure a difference between predictions made for some or all the regions or the objects using the machine learning algorithm and ground truth labels provided for the mini-sets of images.

In some embodiments, the training of the second phase comprises performing iterative operations to learn a set of parameters to detect, characterize, classify, or a combination thereof some or all regions or objects within the second annotated training set of images that maximizes or minimizes a cost function, where each iteration involves finding the set of parameters for the preconditioned machine learning model so that a value of the cost function using the set of parameters is larger or smaller than a value of the cost function using another set of parameters in a previous iteration, and where the cost function is constructed to measure a difference between predictions made for some or all the regions or the objects using the preconditioned machine learning model and ground truth labels provided for the second annotated training set of images.

In some embodiments, the computer-implemented method further comprises: identifying a digital pathology scenario; selecting an adaptive continual learning method for updating the target machine learning model given the digital pathology scenario; and updating the target machine learning model based on the adaptive continual learning method to generate an updated machine learning model.

In some embodiments, the digital pathology scenario is a data incremental scenario, a domain incremental scenario, class incremental scenario, or a task incremental scenario.

In some embodiments, the adaptive continual learning method is selected from the group comprising: Elastic Weight Consolidation (EWC), Learning without Forgetting (LWF), Incremental Learner and Representation Learning (iCaRL), Continual Prototype Evaluation (CoPE), A-GEM, and a parameter isolation method.

In some embodiments, the computer-implemented method further comprises providing the target machine learning model and/or the updated machine learning model.

In some embodiments, the providing comprises deploying the target machine learning model and/or the updated machine learning model in a digital pathology system.

In some embodiments, the computer-implemented method further comprises: receiving, by the data processing system, a new image; inputting the new image into the target machine learning model or the updated machine learning model; detecting, characterizing, classifying, or a combination thereof, by the target machine learning model or the updated machine learning model, some or all regions or objects within the new images; and outputting, by the target machine learning model or the updated machine learning model, an inference based on the detecting, characterizing, classifying, or a combination thereof.

In some embodiments, the computer-implemented method further comprises determining, by a user, a diagnosis of a subject associated with the new image, where the diagnosis is determined based on the inference output by the target machine learning model or the updated machine learning model.

In some embodiments, the computer-implemented method further comprises administering, by the user, a treatment to the subject based on (i) inference output by the target machine learning model or the updated machine learning model, and/or (ii) the diagnosis of the subject.

In some embodiments, the training the machine learning algorithm comprises implementing meta-learning principles to enable the first phase to use the limited number of examples to generate the preconditioned machine learning model.

In some embodiments, the training the preconditioned machine learning model comprises implementing meta-learning principles to enable the second phase to use the limited number of images to generate the target machine learning model.

In some embodiments, a system is provided that includes one or more data processors and a non-transitory computer readable storage medium containing instructions which, when executed on the one or more data processors, cause the one or more data processors to perform part or all of one or more methods disclosed herein.

In some embodiments, a computer-program product is provided that is tangibly embodied in a non-transitory machine-readable storage medium and that includes instructions configured to cause one or more data processors to perform part or all of one or more methods disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Aspects and features of the various embodiments will be more apparent by describing examples with reference to the accompanying drawings, in which:

FIG. 1 illustrates the challenge for artificial intelligence-based digital pathology algorithms to efficiently adapt to ever-increasing data complexity.

FIG. 2 illustrates efficient model development with the adaptive learning framework in accordance with various embodiments.

FIG. 3 illustrates a comparison of resource demand for training from scratch, transfer learning, and adaptive learning.

FIG. 4 shows an exemplary network for generating digital pathology images in accordance with various embodiments.

FIG. 5 shows an overview of the adaptive learning framework in accordance with various embodiments.

FIG. 6 shows example IHC images and ground-truths for cell detection in accordance with various embodiments.

FIG. 7 shows an example of adaptively learning an increasing number of data with similarities for hematoxylin and eosin (H&E) tissue type classification (data-incremental) in accordance with various embodiments.

FIG. 8 shows an example of adaptively learning an increasing number of data sources for H&E tissue type classification (domain-incremental) in accordance with various embodiments.

FIG. 9 shows an example of adaptively learning an increasing number of tissue types for H&E tissue type classification (class-incremental) in accordance with various embodiments.

FIG. 10 shows an exemplary computing environment for processing digital pathology images using a machine learning/deep learning model in accordance with various embodiments.

FIG. 11 shows a flowchart illustrating a process for training and using a machine learning model in accordance with various embodiments of the disclosure.

FIG. 12 shows example images from a CRC training dataset in accordance with various embodiments.

FIG. 13 shows example images from PatchCam dataset in accordance with various embodiments.

FIG. 14 shows the accuracy of test streams at the end of each main experience under a class incremental setup with the augmented CRC dataset using COPE with two baselines in accordance with various embodiments.

FIG. 15 shows example images from the augmented training dataset in accordance with various embodiments.

FIG. 16 shows accuracy (left) and forgetting (right) of test streams at the end of each main experience under a domain incremental setup with the augmented CRC dataset using LwF in accordance with various embodiments.

FIG. 17 shows the accuracy of test streams at the end of each main experience under a data incremental setup with the augmented CRC dataset using iCaRL in accordance with various embodiments.

FIG. 18 shows overall accuracy at the end of training data, domain and class incremental scenarios from different continuous learning methods, along with two baselines in accordance with various embodiments.

FIG. 19 shows continuous learning method performance in a data incremental scenario in accordance with various embodiments.

FIG. 20 shows continuous learning method performance in a domain incremental scenario in accordance with various embodiments.

FIG. 21 shows continuous learning method performance in a class incremental scenario in accordance with various embodiments.

FIG. 22 shows results from A-GEM with augmented CRC data set up as a task incremental scenario in accordance with various embodiments.

FIG. 23 shows an accuracy of test streams at the end of each main experience under a domain incremental setup with the augmented CRC dataset using CoPE in accordance with various embodiments.

FIG. 24 shows impact of class grouping and experience setting on class incremental performance with iCaRL in accordance with various embodiments.

FIG. 25 shows continually learning from different tumor types in a domain incremental setting with LwF in accordance with various embodiments.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

### I. Overview

Artificial intelligence and machine learning based approaches have achieved unprecedented performance in solving complex problems in digital pathology-based analysis, which reduces the workload of pathologists by automatically suggesting potential lesions and thus improving their confidence in diagnosis and reducing subjectivity. A general strategy to ensure reliable and credible digital pathology algorithm performance is to collect and train a model from scratch with a large number of annotations for each target image domain in digital pathology, both during (a) initial model training and (b) model updating phases for either performance improvement or adaptation to a different image domain. However, fundamental tasks for histopathology image analysis, such as image classification, semantic segmentation and object detection, require manual creation and curation of annotations by pathologists. Such time-consuming and resource-intensive model development has led to two primary challenges in digital pathology.

Firstly, the challenge of efficiently and effectively establishing an artificial intelligence model for a target digital pathology dataset. Due to its nature of being data-hungry and limited generalizability to unseen data distributions, most deep-learning models take many months to develop, where a large set of annotations specific for a target dataset needs to be generated and validated by qualified experts. However, with such a time-consuming and resource-intensive development process, challenges are faced to meet an ever-increasing demand for such models. Considering the emerging multiplexing technologies in the market: in the incoming years a diverse set of new assays will be developed together with deep-learning-based digital pathology analysis. In addition, ever-evolving patient populations and unpredictable disease outbreaks require efficient model development strategies to cope with changing needs in diagnosis.

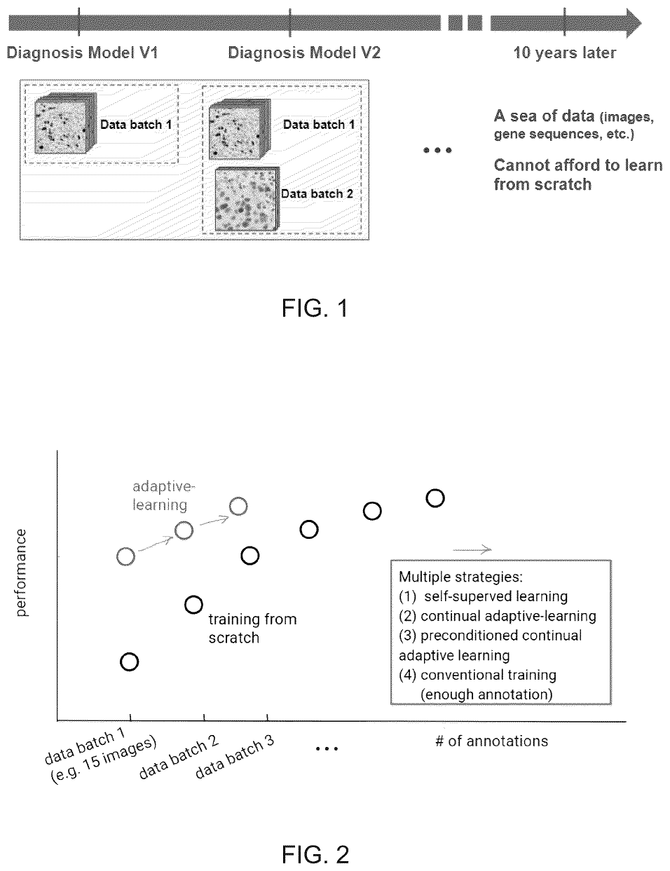

Secondly, the challenge of efficiently adapting an existing model system to related but different datasets. Image digitization conditions are constantly evolving especially with technological advances. Use of different staining chromogens, changes in stains, digital scanners and vendor platforms will result in a shift in appearance of the digitized image. Popularity and availability of digital pathology also produces a near continuous stream of data with biological variance due to heterogeneous disease samples to analyze. Ever growing data volume and complexity requires developing artificial intelligence algorithms that can adapt and sustain performance under a variety of conditions. Traditional approaches of retraining on newer batches of data with manual, task-specific annotations quickly increase the demand for data storage, training time and computational power, subsequently increasing cost, delaying product release and eventually reaching a point where it is prohibitively costly for an organization, as shown in FIG. 1.

Active-learning-based approaches have been designed to reduce the number of annotations required for model development since the pre-deep-learning era. These approaches utilize heuristic scoring strategies to query a small subset of unlabeled examples, which are the most informative within the dataset. By iteratively adding only a small set of such selected examples for model retraining, active learning aims at gradually improving model performance, thus avoiding the need to annotate a large number of potentially less-informative examples. However, models developed with active learning only apply to test images of the same or identical distribution as the training images. For example, a model trained with active learning on one immunohistochemistry (IHC) assay (Domain 1) cannot be generalized to another domain, such as another IHC assay (Domain 2). As another example, a model trained with one tissue type is not readily transferable to other tissue types. Thus, such approaches are distinct from the adaptive learning framework disclosed herein and cannot fully address the challenges of model inflexibility and lack of model adaptability. In addition, active learning requires iterative model re-training with all existing as well as newly annotated examples at each development iteration and thus cannot help reduce the demand for computational power and storage space.

Alternatively, transfer learning and domain adaptation have been used to improve model generalization to a certain extent. With transfer learning, the entirety or portion of the model weights, is trained on a large annotated dataset applied to a new image domain; whereas domain adaptation aims to use only a few annotations or no annotations from a target domain for model development. However, both frameworks can suffer from catastrophic forgetting: when a model trained on one image domain (source domain) is leveraged to train on another image domain (target domain), its performance on the source domain drops considerably and thus “forgetting” the knowledge learned from previous training processes on the source domain data. Although domain adaptation algorithms aim at generating models with good performance for both source and target domain, even without annotations from the target domain (unsupervised domain adaptation), current practice still relies on a validation set from the targeting domain for model selection, which inevitably tends to overfit to the validation set.

To address these challenges and others, various embodiments disclosed herein are directed to methods, systems, and computer readable storage media to: (1) reduce the resource demand needed to develop artificial intelligence-models for unseen distributions of digital pathology data in the initial model development phase and (2) reduce the resource demand for subsequent iterations of model development, which aims at improving or adapting the initial artificial intelligence-models built following (1) to related but not entirely identical datasets.

To reduce resource demand in the initial model development phase, techniques are implemented to precondition artificial intelligence systems for learning useful features from existing digital pathology data. Such a design leverages existing annotated digital pathology datasets that are related but not necessarily similar to the target data, which enable artificial intelligence systems to distill their learning skills through a pre-training phase using these related datasets. Herein, “learning skills” include one or more of the following: the best sets of model initializations, the best sets of model weights that can be generalized to unseen data, the best sets of model architectures, and the like. With these learning skills, a preconditioned model only requires a small set of annotations to achieve reasonable performance. For example, achieving 75% accuracy with <50 annotated images for classifying tissue types from a tumor type the model has not trained with, versus >2000 images for training a model specific for this tumor type using traditional artificial intelligence models.

To reduce resource demand in the subsequent model development or model adaptation to different datasets, continual learning techniques and algorithms are implemented to enable model updates with sequentially obtained data without training the model with all the existing and new datasets from scratch. While continual learning algorithms offer a solution to learn from sequential streams of data, it is a challenge to make sure old knowledge is not forgotten (catastrophic forgetting). To select the most effective continual learning algorithm for diverse digital pathology data, a set of strategies is designed for targeting various model update requirements commonly encountered in digital pathology applications and corresponding algorithms are implemented for continually learning without training from scratch and without model performance drop for previously encountered data (e.g., catastrophic forgetting by the machine learning models).

These various techniques and algorithms are implemented in an adaptive learning framework that includes the following features and advantages.
(1) Effectively reduce resource demand throughout the entire development process of artificial intelligence-based digital pathology algorithms. The adaptive learning framework addresses the challenge of otherwise resource-demanding processes of both initial model development and subsequent model update/adaptation, as shown in FIG. 2. The adaptive learning framework enables efficient initial model development with a small number of annotations (e.g., less than 50) and faster model improvement to reach convergence to a good model performance (adaptive learning dots) compared with conventional artificial intelligence strategies (training from scratch dots). The arrows demonstrate the model update process, where various methods can be applied, including self-supervised learning, continual adaptive learning, preconditioned continual adaptive learning (with small sets of annotations), conventional training (with enough annotation).
(2) The adaptive learning framework can be applied to model development targeting images from different image domains in digital pathology. Herein, an image domain refers to a set of images with a specific sample distribution. Examples of different image domains include different image modalities (IHC images vs. H&E images), IHC assays (IHC targeting Ki67 vs. CK7 vs. PDL1-CK7), tumor types and subtypes (breast cancer vs. lung cancer), scanners from different vendors, etc.
(3) The adaptive learning framework leverages existing digital pathology datasets (from one or multiple image domains) during the preconditioning phase for initial model development and the corresponding pre-conditioned model can be applied to the same or a related but different image domain than the image domain(s) in the preconditioning phase.
(4) The designed algorithms for model update strategy selection enables effective extension of an existing model to adapt to a different image domain after initial model development.
(5) A user such as a developer can flexibly apply only the initial model development strategy, only the model update strategy, or both depending on the availability of the initial model and the need to update the model to a new image dataset or a new domain. Alternatively, self-supervised pre-training can be combined with the pre-conditioning and model-updating strategies at one or all multiple model development iterations.
(6) The adaptive learning framework is domain-agnostic and can be applied to other imaging modalities as well as other computational studies, such as multi-modal analysis, gene sequencing signal analysis, survival modeling, etc.

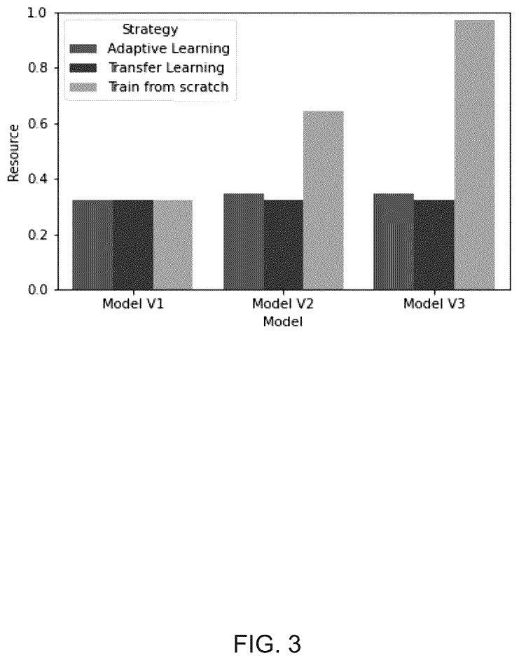

FIG. 3 shows a comparison of resource demand for training from scratch, transfer learning, and the adaptive learning framework described herein. The resource (y-axis) refers to the number of total images that needs to be computed for model training of various subsequent model versions (x-axis): if one image is processed N times, then it is counted as N images. Training from scratch consumes most resources and the demand grows quickly. Transfer learning only needs the resource for computing the new batch of data. Adaptive learning requires similar computing resources with negligible increase than the transfer learning.

In one illustrative embodiment, a computer-implemented process is provided that comprises: obtaining, at a data processing system, a first annotated training set of images for training a machine learning algorithm to detect, characterize, classify, or a combination thereof some or all regions or objects within the images, where the first annotated training set of images are in a first image domain; splitting, by the data processing system, the first annotated training set of images into mini-sets of images each mini-set representing a distinct modeling subtask and comprising a limited number of examples; training, by the data processing system, the machine learning algorithm in a first phase using the mini-sets of images to generate a preconditioned machine learning model configured to detect, characterize, classify, or a combination thereof some or all regions or objects within new images; label, by the data processing system, a limited number of images from a target dataset to generate a second annotated training set of images for training a machine learning algorithm to detect, characterize, classify, or a combination thereof some or all regions or objects within the images, where the second annotated training set of images are in a second image domain; and training, by the data processing system, the preconditioned machine learning model in a second phase using the second annotated training set of images to generate a target machine learning model configured to detect, characterize, classify, or a combination thereof some or all regions or objects within the new images, where a number of classes being trained on in the first phase are a part of or match the number of classes being trained on in the second phase.

In some embodiments, the computer-implemented process further comprises: identifying a digital pathology scenario; selecting an adaptive continual learning method for updating the target machine learning model given the digital pathology scenario; and updating the target machine learning model based on the adaptive continual learning method to generate an updated machine learning model.

Advantageously, the various techniques described herein can improve robustness of the machine learning models (e.g., improve accuracy in cell classification).

### II. Definitions

As used herein, when an action is “based on” something, this means the action is based at least in part on at least a part of the something.

As used herein, the terms “substantially,” “approximately,” and “about” are defined as being largely but not necessarily wholly what is specified (and include wholly what is specified) as understood by one of ordinary skill in the art. In any disclosed embodiment, the term “substantially,” “approximately,” or “about” may be substituted with “within [a percentage] of” what is specified, where the percentage includes 0.1, 1, 5, and 10 percent.

As used herein, the term “sample,” “biological sample,” “tissue,” or “tissue sample” refers to any sample including a biomolecule (such as a protein, a peptide, a nucleic acid, a lipid, a carbohydrate, or a combination thereof) that is obtained from any organism including viruses. Other examples of organisms include mammals (such as humans; veterinary animals like cats, dogs, horses, cattle, and swine; and laboratory animals like mice, rats and primates), insects, annelids, arachnids, marsupials, reptiles, amphibians, bacteria, and fungi. Biological samples include tissue samples (such as tissue sections and needle biopsies of tissue), cell samples (such as cytological smears such as Pap smears or blood smears or samples of cells obtained by microdissection), or cell fractions, fragments or organelles (such as obtained by lysing cells and separating their components by centrifugation or otherwise). Other examples of biological samples include blood, serum, urine, semen, fecal matter, cerebrospinal fluid, interstitial fluid, mucous, tears, sweat, pus, biopsied tissue (for example, obtained by a surgical biopsy or a needle biopsy), nipple aspirates, cerumen, milk, vaginal fluid, saliva, swabs (such as buccal swabs), or any material containing biomolecules that is derived from a first biological sample. In certain embodiments, the term “biological sample” as used herein refers to a sample (such as a homogenized or liquefied sample) prepared from a tumor or a portion thereof obtained from a subject.

As used herein, the term “biological material,” “biological structure,” or “cell structure” refers to natural materials or structures that comprise a whole or a part of a living structure (e.g., a cell nucleus, a cell membrane, cytoplasm, a chromosome, DNA, a cell, a cluster of cells, or the like).

As used herein, a “digital pathology image” refers to a digital image of a stained sample.

As used herein, the term “cell detection” refers to detection of the pixel locations and characteristics of a cell or a cell structure (e.g., a cell nucleus, a cell membrane, cytoplasm, a chromosome, DNA, a cell, a cluster of cells, or the like).

As used herein, the term “target region” refers to a region of an image including image data that is intended be assessed in an image analysis process. Target regions include any region such as tissue regions of an image that is intended to be analyzed in the image analysis process (e.g., tumor cells or staining expressions).

As used herein, the term “tile” or “tile image” refers to a single image corresponding to a portion of a whole image, or a whole slide. In some embodiments, “tile” or “tile image” refers to a region of a whole slide scan or an area of interest having (x,y) pixel dimensions (e.g., 1000 pixels by 1000 pixels). For example, consider a whole image split into M columns of tiles and N rows of tiles, where each tile within the M×N mosaic comprises a portion of the whole image, i.e. a tile at location M₁, N₁ comprises a first portion of an image, while a tile at location M₁, N₂ comprises a second portion of the image, the first and second portions being different. In some embodiments, the tiles may each have the same dimensions (pixel size by pixel size). In some instances, tiles can overlap partially, representing overlapping regions of a whole slide scan or an area of interest.

As used herein, the term “patch,” “image patch,” or “mask patch” refers to a container of pixels corresponding to a portion of a whole image, a whole slide, or a whole mask. In some embodiments, “patch,” “image patch,” or “mask patch” refers to a region of an image or a mask, or an area of interest having (x, y) pixel dimensions (e.g., 256 pixels by 256 pixels). For example, an image of 1000 pixels by 1000 pixels divided into 100 pixel×100 pixel patches would comprise 10 patches (each patch containing 1000 pixels). In other embodiments, the patches overlap with each “patch,” “image patch,” or “mask patch” having (x, y) pixel dimensions and sharing one or more pixels with another “patch,” “image patch,” or “mask patch.”

### III. Generation of Digital Pathology Images

Digital pathology involves the interpretation of digitized images in order to correctly diagnose subjects and guide therapeutic decision making. In digital pathology solutions, image-analysis workflows can be established to automatically detect or classify biological objects of interest e.g., positive, negative tumor cells, etc. An exemplary digital pathology solution workflow includes obtaining tissue slides, scanning preselected areas or the entirety of the tissue slides with a digital image scanner (e.g., a whole slide image (WSI) scanner) to obtain digital images, performing image analysis on the digital image using one or more image analysis algorithms, and potentially detecting, quantifying (e.g., counting or identify object-specific or cumulative areas of) each object of interest based on the image analysis (e.g., quantitative or semi-quantitative scoring such as positive, negative, medium, weak, etc.).

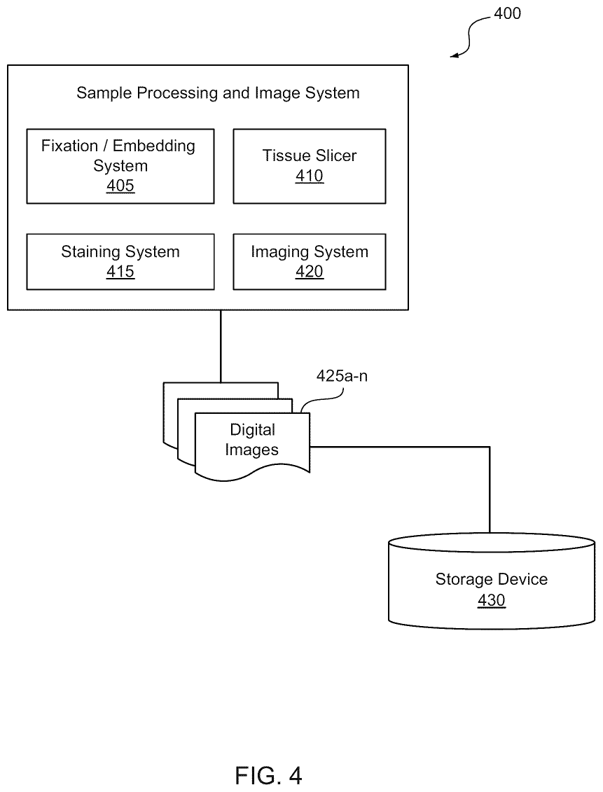

FIG. 4 shows an exemplary network 400 for generating digital pathology images. A fixation/embedding system 405 fixes and/or embeds a tissue sample (e.g., a sample including at least part of at least one tumor) using a fixation agent (e.g., a liquid fixing agent, such as a formaldehyde solution) and/or an embedding substance (e.g., a histological wax, such as a paraffin wax and/or one or more resins, such as styrene or polyethylene). Each sample may be fixed by exposing the sample to a fixating agent for a predefined period of time (e.g., at least 3 hours) and by then dehydrating the sample (e.g., via exposure to an ethanol solution and/or a clearing intermediate agent). The embedding substance can infiltrate the sample when it is in liquid state (e.g., when heated).

Sample fixation and/or embedding is used to preserve the sample and slow down sample degradation. In histology, fixation generally refers to an irreversible process of using chemicals to retain the chemical composition, preserve the natural sample structure, and maintain the cell structure from degradation. Fixation may also harden the cells or tissues for sectioning. Fixatives may enhance the preservation of samples and cells using cross-linking proteins. The fixatives may bind to and cross-link some proteins, and denature other proteins through dehydration, which may harden the tissue and inactivate enzymes that might otherwise degrade the sample. The fixatives may also kill bacteria.

The fixatives may be administered, for example, through perfusion and immersion of the prepared sample. Various fixatives may be used, including methanol, a Bouin fixative and/or a formaldehyde fixative, such as neutral buffered formalin (NBF) or paraffin-formalin (paraformaldehyde-PFA). In cases where a sample is a liquid sample (e.g., a blood sample), the sample may be smeared onto a slide and dried prior to fixation. While the fixing process may serve to preserve the structure of the samples and cells for the purpose of histological studies, the fixation may result in concealing of tissue antigens thereby decreasing antigen detection. Thus, the fixation is generally considered as a limiting factor for immunohistochemistry because formalin can cross-link antigens and mask epitopes. In some instances, an additional process is performed to reverse the effects of cross-linking, including treating the fixed sample with citraconic anhydride (a reversible protein cross-linking agent) and heating.

Embedding may include infiltrating a sample (e.g., a fixed tissue sample) with a suitable histological wax, such as paraffin wax. The histological wax may be insoluble in water or alcohol, but may be soluble in a paraffin solvent, such as xylene. Therefore, the water in the tissue may need to be replaced with xylene. To do so, the sample may be dehydrated first by gradually replacing water in the sample with alcohol, which can be achieved by passing the tissue through increasing concentrations of ethyl alcohol (e.g., from 0 to about 100%). After the water is replaced by alcohol, the alcohol may be replaced with xylene, which is miscible with alcohol. Because the histological wax may be soluble in xylene, the melted wax may fill the space that is filled with xylene and was filled with water before. The wax filled sample may be cooled down to form a hardened block that can be clamped into a microtome, vibratome, or compresstome for section cutting. In some cases, deviation from the above example procedure may result in an infiltration of paraffin wax that leads to inhibition of the penetration of antibody, chemical, or other fixatives.

A tissue slicer 410 may then be used for sectioning the fixed and/or embedded tissue sample (e.g., a sample of a tumor). Sectioning is the process of cutting thin slices (e.g., a thickness of, for example, 4-5 μm) of a sample from a tissue block for the purpose of mounting it on a microscope slide for examination. Sectioning may be performed using a microtome, vibratome, or compresstome. In some cases, tissue can be frozen rapidly in dry ice or Isopentane, and can then be cut in a refrigerated cabinet (e.g., a cryostat) with a cold knife. Other types of cooling agents can be used to freeze the tissues, such as liquid nitrogen. The sections for use with brightfield and fluorescence microscopy are generally on the order of 4-10 μm thick. In some cases, sections can be embedded in an epoxy or acrylic resin, which may enable thinner sections (e.g., <2 μm) to be cut. The sections may then be mounted on one or more glass slides. A coverslip may be placed on top to protect the sample section.

Because the tissue sections and the cells within them are virtually transparent, preparation of the slides typically further includes staining (e.g., automatically staining) the tissue sections in order to render relevant structures more visible. In some instances, the staining is performed manually. In some instances, the staining is performed semi-automatically or automatically using a staining system 415. The staining process includes exposing sections of tissue samples or of fixed liquid samples to one or more different stains (e.g., consecutively or concurrently) to express different characteristics of the tissue.

For example, staining may be used to mark particular types of cells and/or to flag particular types of nucleic acids and/or proteins to aid in the microscopic examination. The staining process generally involves adding a dye or stain to a sample to qualify or quantify the presence of a specific compound, a structure, a molecule, or a feature (e.g., a subcellular feature). For example, stains can help to identify or highlight specific biomarkers from a tissue section. In other example, stains can be used to identify or highlight biological tissues (e.g., muscle fibers or connective tissue), cell populations (e.g., different blood cells), or organelles within individual cells.

One exemplary type of tissue staining is histochemical staining, which uses one or more chemical dyes (e.g., acidic dyes, basic dyes, chromogens) to stain tissue structures. Histochemical staining may be used to indicate general aspects of tissue morphology and/or cell microanatomy (e.g., to distinguish cell nuclei from cytoplasm, to indicate lipid droplets, etc.). One example of a histochemical stain is H&E. Other examples of histochemical stains include trichrome stains (e.g., Masson's Trichrome), Periodic Acid-Schiff (PAS), silver stains, and iron stains. The molecular weight of a histochemical staining reagent (e.g., dye) is typically about 500 kilodaltons (kD) or less, although some histochemical staining reagents (e.g., Alcian Blue, phosphomolybdic acid (PMA)) may have molecular weights of up to two or three thousand kD. One case of a high-molecular-weight histochemical staining reagent is alpha-amylase (about 55 kD), which may be used to indicate glycogen.

Another type of tissue staining is IHC, also called “immunostaining”, which uses a primary antibody that binds specifically to the target antigen of interest (also called a biomarker). IHC may be direct or indirect. In direct IHC, the primary antibody is directly conjugated to a label (e.g., a chromophore or fluorophore). In indirect IHC, the primary antibody is first bound to the target antigen, and then a secondary antibody that is conjugated with a label (e.g., a chromophore or fluorophore) is bound to the primary antibody. The molecular weights of IHC reagents are much higher than those of histochemical staining reagents, as the antibodies have molecular weights of about 150 kD or more.

Various types of staining protocols may be used to perform the staining. For example, an exemplary IHC staining protocol includes using a hydrophobic barrier line around the sample (e.g., tissue section) to prevent leakage of reagents from the slide during incubation, treating the tissue section with reagents to block endogenous sources of nonspecific staining (e.g., enzymes, free aldehyde groups, immunoglobins, other irrelevant molecules that can mimic specific staining), incubating the sample with a permeabilization buffer to facilitate penetration of antibodies and other staining reagents into the tissue, incubating the tissue section with a primary antibody for a period of time (e.g., 1-24 hours) at a particular temperature (e.g., room temperature, 6-8° C.), rinsing the sample using wash buffer, incubating the sample (tissue section) with a secondary antibody for another period of time at another particular temperature (e.g., room temperature), rinsing the sample again using water buffer, incubating the rinsed sample with a chromogen (e.g., DAB: 3,3′-diaminobenzidine), and washing away the chromogen to stop the reaction. In some instances, counterstaining is subsequently used to identify an entire “landscape” of the sample and serve as a reference for the main color used for the detection of tissue targets. Examples of the counterstains may include hematoxylin (stains from blue to violet), Methylene blue (stains blue), toluidine blue (stains nuclei deep blue and polysaccharides pink to red), nuclear fast red (also called Kernechtrot dye, stains red), and methyl green (stains green); non-nuclear chromogenic stains, such as eosin (stains pink), etc. A person of ordinary skill in the art will recognize that other immunohistochemistry staining techniques can be implemented to perform staining.

In another example, an H&E staining protocol can be performed for the tissue section staining. The H&E staining protocol includes applying hematoxylin stain mixed with a metallic salt, or mordant to the sample. The sample can then be rinsed in a weak acid solution to remove excess staining (differentiation), followed by bluing in mildly alkaline water. After the application of hematoxylin, the sample can be counterstained with eosin. It will be appreciated that other H&E staining techniques can be implemented.

In some embodiments, various types of stains can be used to perform staining, depending on which features of interest is targeted. For example, DAB can be used for various tissue sections for the IHC staining, in which the DAB results a brown color depicting a feature of interest in the stained image. In another example, alkaline phosphatase (AP) can be used for skin tissue sections for the IHC staining, since DAB color may be masked by melanin pigments. With respect to primary staining techniques, the applicable stains may include, for example, basophilic and acidophilic stains, hematin and hematoxylin, silver nitrate, trichrome stains, and the like. Acidic dyes may react with cationic or basic components in tissues or cells, such as proteins and other components in the cytoplasm. Basic dyes may react with anionic or acidic components in tissues or cells, such as nucleic acids. As noted above, one example of a staining system is H&E. Eosin may be a negatively charged pink acidic dye, and hematoxylin may be a purple or blue basic dye that includes hematein and aluminum ions. Other examples of stains may include periodic acid-Schiff reaction (PAS) stains, Masson's trichrome, Alcian blue, van Gieson, Reticulin stain, and the like. In some embodiments, different types of stains may be used in combination.

The sections may then be mounted on corresponding slides, which an imaging system 420 can then scan or image to generate raw digital-pathology images 425a-n. A microscope (e.g., an electron or optical microscope) can be used to magnify the stained sample. For example, optical microscopes may have a resolution less than 1 μm, such as about a few hundred nanometers. To observe finer details in nanometer or sub-nanometer ranges, electron microscopes may be used. An imaging device (combined with the microscope or separate from the microscope) images the magnified biological sample to obtain the image data, such as a multi-channel image (e.g., a multi-channel fluorescent) with several (such as between ten to sixteen, for example) channels. The imaging device may include, without limitation, a camera (e.g., an analog camera, a digital camera, etc.), optics (e.g., one or more lenses, sensor focus lens groups, microscope objectives, etc.), imaging sensors (e.g., a charge-coupled device (CCD), a complimentary metal-oxide semiconductor (CMOS) image sensor, or the like), photographic film, or the like. In digital embodiments, the imaging device can include a plurality of lenses that cooperate to prove on-the-fly focusing. An image sensor, for example, a CCD sensor can capture a digital image of the biological sample. In some embodiments, the imaging device is a brightfield imaging system, a multispectral imaging (MSI) system or a fluorescent microscopy system. The imaging device may utilize nonvisible electromagnetic radiation (UV light, for example) or other imaging techniques to capture the image. For example, the imaging device may comprise a microscope and a camera arranged to capture images magnified by the microscope. The image data received by the analysis system may be identical to and/or derived from raw image data captured by the imaging device.

The images of the stained sections may then be stored in a storage device 425 such as a server. The images may be stored locally, remotely, and/or in a cloud server. Each image may be stored in association with an identifier of a subject and a date (e.g., a date when a sample was collected and/or a date when the image was captured). An image may further be transmitted to another system (e.g., a system associated with a pathologist, an automated or semi-automated image analysis system, or a machine learning training and deployment system, as described in further detail herein).

It will be appreciated that modifications to processes described with respect to network 400 are contemplated. For example, if a sample is a liquid sample, embedding and/or sectioning may be omitted from the process.

### IV. Adaptive Learning Framework

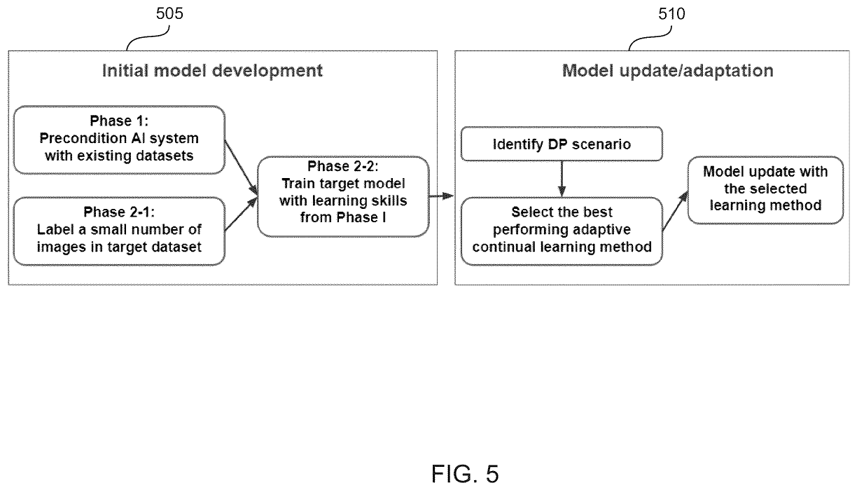

FIG. 5 shows the adaptive learning framework includes two components: (505) development of initial models, and (510) model update and/or adaptation to a different image domain. The two components 505; 510 can be applied separately or all together: initial model development and subsequent model update and/or adaptation to different image domains.

### Development of Initial Models

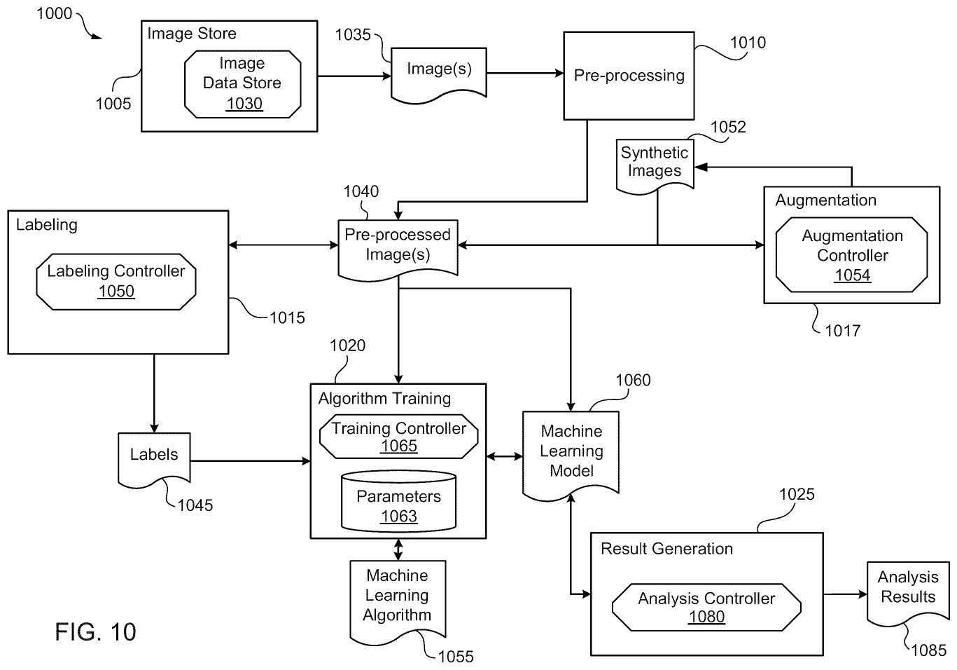

For efficient development of initial models, a two-step development strategy (shown in FIG. 5) is as follows: Phase 1: Model preconditioning, where an artificial intelligence system (e.g., an artificial intelligence system described in detail with respect to FIG. 10) leverages existing annotated datasets and improves learning skills through training with these datasets. Phase 2: Target-model training, where the artificial intelligence system utilizes the learning skills learned from Phase 1 to extend itself to a different image domain (target domain) with a smaller number of annotations required in the target domain than conventional learning methods.

The aforementioned “learning skills” include one or more of the following: the best sets of model initializations, the best sets of model weights that can be generalized to unseen data, the best sets of model architectures, and the like. The best being determined using one or more metrics for measuring model performance such as accuracy or area under the curve (AUC). The learning skills are then applied to the target image domain, so that a smaller number of annotations is needed for the target domain than conventional machine learning.

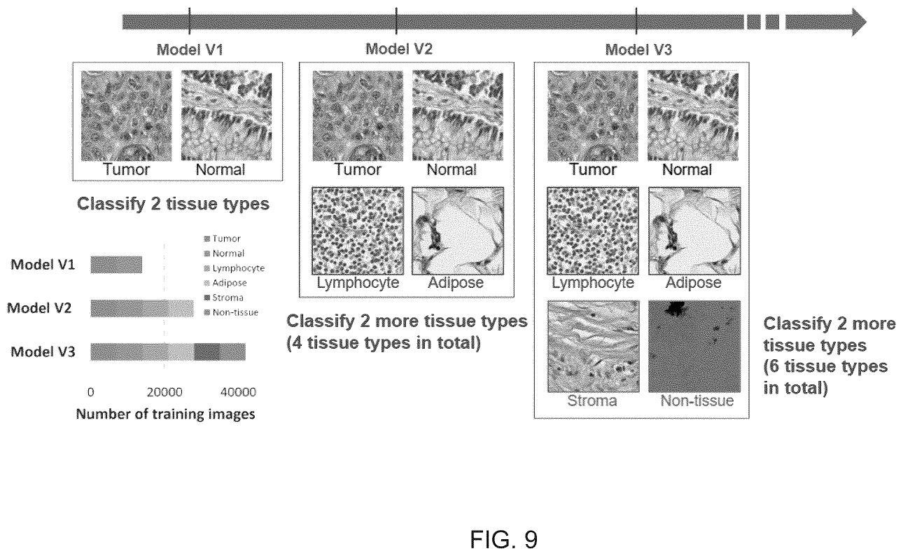

To achieve the model preconditioning, a meta-learning strategy may be adopted, where existing datasets (e.g., training datasets) are split into mini-sets, each representing a distinct modeling subtask and containing only a few number of examples, thus forming a large number of subtasks. The split can be performed at training time and at each model training iteration a different data split can be performed. Training an artificial intelligence system with these subtasks enables the artificial intelligence system to search for superior solutions in the model optimization landscape, which can generalize to any related small subtask without overfitting to a particular subtask, thus preconditioning the artificial intelligence system to Phase 2 for an unseen target domain. In general, the number of classes in Phase 1 training is configured to be a part of or match that of Phase 2 training. With class incremental scenario in Phase 2, the number of classes in Phase 1 can be increased; whereas with domain and data incremental scenario in Phase 2, the number of classes from Phase 1 should be matched. In certain instance, the number of classes in Phase 2 can be larger than Phase 1 (described in detail with respect to FIG. 9). In classification tasks (e.g., binary and multi-class classification), the class labels are at the image level, e.g., a class (or multiple classes) is set to the entire image. In prediction tasks (e.g., dense predictions), such as image segmentation and object detection, the class labels are at a more fine-grained level: for example, for object detection, each distinct object in an image has the label for its class and location. The training datasets used for model preconditioning can be related to one another but with various extent of similarities to those of the target domain.

The following criteria may be implemented for sampling the existing annotated datasets. (1) If only one annotated dataset is available, for each subtask, a subset of classes may be randomly selected to be a part of or match the number of classes for Phase 2 and a few examples can be randomly selected from the selected classes. In this scenario, there are a large number of subtasks with different or partially different classes. (2) If multiple annotated datasets are available, for each subtask, examples can either be mixed from multiple datasets and then the mixed dataset can be implemented the same way as in (1), or a certain dataset can initially be randomly selected and then a subset of classes in that dataset can be randomly selected to be a part of or match the number of classes in Phase 2. In both scenarios, (a) sampling strategies other than complete randomness can also be adopted, for example, some classes or some datasets can be sampled more frequently than the others; and/or (b) the examples in each subtask may be split into training and validation subsets.

More specifically, for image-level predictions, e.g., image classification tasks, an “example” refers to an image with its class label in a dataset, i.e., each subtask is comprised of a set of images, all of which belong to the selected classes. Within each subtask, the image class labels are redefined for the training process in Phase 1. For example, 15 images may be selected with 5 images per class, e.g., 3 classes in total; regardless of the original class labels for each image, for the Phase 1 training, a random ordering of classes are generated, whereby any of the 3 classes can be set as Class No.0, another class can be set as Class No.1 and the last class left can be set as Class No.2. In the next subtask, another 15 images from a different set of classes can be selected and then their class labels are again reset in random order to be 0, 1 and 2. In this way, the model becomes class-agnostic in the sense that the model does not focus on learning information from each particular class, but learns how to improve learning skills for all possible subtasks it encounters.

For prediction tasks (e.g., dense predictions), an example includes all the annotated entities (a region or an object) of the same class in an image along with their labels; when sampling a few examples from a selected subset of classes, a few images are initially selected that contain at least one labeled entity from the selected classes and then the labeled entities not from selected classes are set to be the background class. For example, in an image segmentation task, the class labels may include foreground classes and a background class (i.e. regions not of interest for modeling purposes); if the selected classes are tumor nests and blood vessels, then all the regions in an image that do not belong to these two classes are relabeled as the background class and all the regions that belong to tumor nests are relabeled randomly as Class No. 0 or No. 1, while the blood vessels regions are relabeled as whichever class index is left after relabeling the tumor regions.

Methods for learning the subtasks can be considered as follows. Metric-based methods, which learn a representation of the existing datasets and distills from these datasets the skill of comparing the similarities between examples of any classes from an unseen target domain. With these methods, the representation learned in Phase 1 can be applied to Phase 2 in the following manner: (a) select a few images in the target domain, (b) annotate these images and apply the preconditioned model to generate a feature vector representation for each example (e.g., the output of the last layer in a convolutional network before the classification layer), (c) combine the representations from examples of the same class to generate one representation per target class, (d) use these processed representations as prototypes for the target classes, (e) generate feature vector representations for images or image regions (or other entities in the case of dense prediction tasks) in the rest of unlabeled target domain, (f) compare each feature vector representation from the unlabeled target domain with the prototypes by calculating a distance between these vectors, for example, cosine distance, and then assign the class label for the unlabeled image or image regions as the prototype class with smallest distance (e.g., most similar). Other techniques for learning the subtasks may be used in combination with the metric-based methods. For example, adversarial generative models may be used, which synthesize images based on the distribution of existing images to increase the number of examples per class in the target image domain with the generated images.

Alternatively, optimization-based methods, which learn the best model weights for initializing a model, so that it can adapt to an unseen target dataset efficiently, only with a few number of examples. With these methods, training for Phase 1 involves two model optimization loops: (a) inner learning-loops, where an artificial intelligence-model updates its model weights on one subtask with a predefined or flexible number of epochs and, which generates a loss for its validation set after model update, denoted as L-subtask-i for the ith-subtask, and (b) outer learning-loop, where the objective is to search for the set of model initialization that generates the best models when used for updating all subtasks, each with only a few annotated examples; this is achieved by finding the model initialization that minimizes the sum of all loss (summing up L-subtask-i, with i ranging from 1 to the number of subtasks) calculated from the validation sets of the subtasks on their validation sets with respect to their model initialization. Other techniques for learning the subtasks may be used in combination with the optimization-based methods. For example, not only searching for the best model initialization but also searching for the best model architectures (e.g., performing neural architecture search).

The workflows described herein for the design of initial model development were applied for cell detection in brightfield IHC assays and tissue type classification in H&E assays as follows. However, it should be understood that similar workflows can also be applied to other staining methods, such as special stains in brightfield assays (e.g., Trichrome Masson assay, which simultaneously stains muscle, collagen fibers, erythrocytes and cell nucleus) and fluorescent IHC assays.

### (i) Model Preconditioning for Cell Detection in IHC Assays:

A goal is to identify the staining phenotype, cell type and cell location in each image. For example, for DAB-Ki67 IHC assay, a cell detection model can be designed to identify tumor cells positively stained with Ki67 (Ki67+ tumor), tumor cells negatively stained with Ki67 (Ki67-tumor), all other cell types/staining types along with the location of each cell nucleus center at a single pixel or along with a bounding box for each cell nucleus (e.g., the pixel locations of a rectangle that circumscribes each cell nucleus), or the pixels of each cell nucleus (e.g., nucleus segmentation masks).

In general, images from brightfield IHC assays are related and have a certain level of similarities in their appearances: the hematoxylin stain is used in most of these assays and stains the cell nucleus, serving as a pointer to where the cells are in the whole-slide images, whereas one or multiple biomarkers are targeted by an IHC staining protocol and correspondingly the cells expressing these biomarkers show colors with the application of chromogens. A “staining pattern” refers to the appearance of the image regions positive for the targeting biomarker in terms of (a) the subcellular and/or cellular localization of the biomarker, (b) stained cell type(s), (c) the stain intensity, (d) frequency of occurrence, and (e) spatial distributions of the positive regions. For example, Ki67 has a nucleus staining pattern, e.g., positive staining signals in IHC images from a Ki67 assay are observed to be located in the cell nucleus, dominantly in either scattered tumor cells or clustered tumor nests, with positive staining signals ranging from low stain intensity to very high intensities.

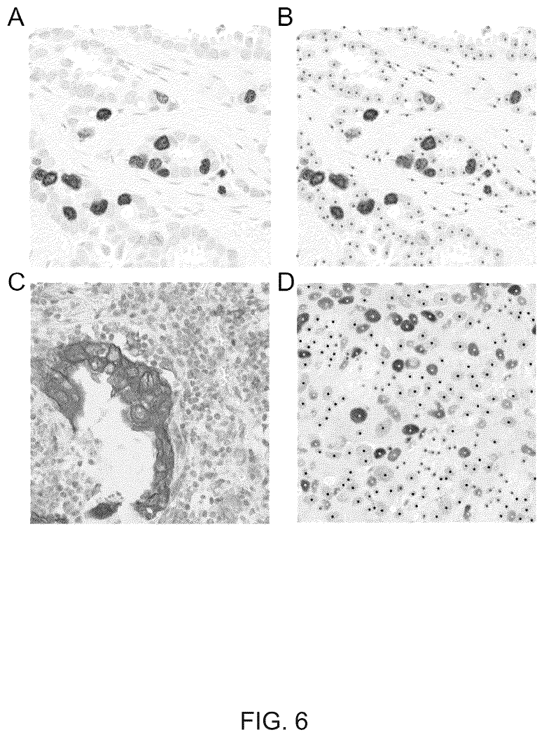

The workflows for preconditioning may be designed using images from various IHC assays with various chromogens and biomarker staining patterns (See, Table 1 for example assays). An exemplary workflow may comprise the following: (1) If the chromogen(s) used in existing annotated datasets are the same as those in target IHC assay(s): (1.1) If only annotations from one assay is available, at each model training iteration, split this dataset into subtasks and sample one subtask for training, which has a few images with cell annotations from one or more classes and making sure cells of all the classes selected for this development phase are present in at least one of the images. For example, precondition on DAB-Ki67 assay and apply to DAB-PDL1 assay. FIG. 6 shows an example DAB-Ki67 IHC image (A) where brown signals are image regions where the chromogen DAB generated colors, indicating these cells where the Ki67 expressed in the cell nucleus were detected by this IHC assay; and grayish-blue signals are hematoxylin-stained cell nucleus. Example ground-truths (B) are also shown for cell detection for the image in (A) where the different colored dots overlaid on the cell nucleus centers show class labels for each cell. (1.2) If annotations from multiple assays are available, to train the preconditioned artificial intelligence system as assay-agnostic as possible, at each model training iteration, initially an assay may be selected from all the assays and then a few examples may be sampled from this assay. For example, the artificial intelligence system may be precondition on DAB-Ki67 and DAB-CK7 assay and applied to a DAB-PDL1 assay.
(2) If the chromogen(s) used in existing annotated datasets are different from those in target IHC assay(s): a workflow similar to (1.1) or (1.2) can be performed. In addition, to match the chromogens in both Phase 1 and Phase 2, a stain unmixing can be performed to decompose the IHC image into each stain component and remixing these components with color vectors extracted from the target IHC assay. For example, the artificial intelligence system may be precondition on Tamra-PDL1/Dabsyl-CK7 duplex assay and applied to DAB-Ki67 assay, where the training system or a user can choose to decompose Tamra-PDL1/Dabsyl-CK7 duplex images into PDL1, CK7 and hematoxylin grayscale intensity images and remix with color vector of DAB to obtain two sets of images for preconditioning phase: synthetic DAB-PDL1 singleplex images and synthetic DAB-CK7 singleplex images. FIG. 6 shows an example Tamra-PDL1-Dabsyl-CK7 IHC image (C). Example ground-truths (D) are also shown for a DAB-PR IHC image where the different colored dots overlaid on the cell nucleus centers show class labels for each cell.

The assays used in the preconditioning phase do not necessarily need to have high similarities to the target domain assays, but if there are some levels of similarities it can be beneficial due to the accumulation of both learning skills and learned knowledge in Phase 1.

TABLE 1
Example assay list

| | | | Dominantly | Example |
|---|---|---|---|---|
| Assay | | Main subcellular | expressing | Tumor |
| No | Biomarker | localization | cell types | type |
| 1 | Ki67 | nucleus | tumor | breast |
| 2 | ER | nucleus | tumor | breast |
| 3 | PR | nucleus | tumor | breast |
| 4 | CD3/CD8 | membrane | lymphocyte | colon |
| 5 | PDL1 | cytoplasm and | tumor, macrophage | breast |
| | | membrane | | |
| 6 | PDL1 | cytoplasm and | tumor, macrophage | lung |
| | | membrane | | |
| 7 | CK7 | cytoplasm, | tumor, normal | lung |
| | | membrane | epithelial | |
| 8 | ER-PR | nucleus | tumor | breast |
| 9 | PDL1-CK7 | cytoplasm and | tumor, macrophage, | lung |
| | | membrane | normal epithelial | |

### (ii) Model Preconditioning for Tissue Type Classification in H&E Assays:

In this instance, the goal is to generate a model to identify the tissue type for each image tile from a whole-slide image. For example, build a model that can classify each image tile into tumor, stroma, normal tissue and other types. Model preconditioning can be performed using similar workflows as described herein with existing datasets from other disease types (e.g., different tumor types) than the target domain, from different disease stages, and the like. Each subtask can be sampled from the same dataset or from a mixture of different datasets if available.

### Model Update and Adaptation

To efficiently perform model update and adaptation to new datasets after initial model development, scenarios commonly encountered in digital pathology settings were identified and techniques were developed to select the most appropriate adaptive-learning methods for the scenarios. Tissue type classification for H&E images is used as an example to illustrate these techniques. However, it should be understood that the techniques described for updating and adaptation of models can be applied to various other scenarios commonly encountered in digital pathology.

When models are trained sequentially, streams of data could be different in different ways. The commonly encountered settings in digital pathology were categorized into the following scenarios:
1. Data incremental scenario: Creating annotated datasets curated by pathologists is a time-consuming process and it is preferable to train the model in batches as and when data arrives. The incoming data, which is considered a new stream to train the model on, has minimal differences with the previous data, is usually from the same underlying distribution and has all the classes as seen previously.
2. Domain incremental: When successive streams of data are from different domains or distributions, it is considered a domain incremental scenario. This scenario is similar to the data incremental scenario in that all streams of data have all the classes represented in them.
3. Class incremental: Class incremental scenario is when a model is expanded in terms of the number of classes. A clinical need for this scenario arises when batches of annotated images contain different subset of classes or model definition changes to classify data into more tissue subtypes. It should be understood that each data stream may include images from new and unseen classes as well as images of seen classes introduced in previous data streams.
4. Task incremental: Any of the above scenarios can be considered as task incremental if each data stream is defined as a new task. This scenario uses a different architectural design-the network has shared layers between tasks as well as task-specific layers.

Each incremental data stream is referred to as an experience. Each experience, in turn, split into train, validation and test streams. The model is trained on the train stream, validated on the validation stream at the end of every epoch and evaluated on the test stream at the end of each experience. The model performance was evaluated on test streams from all experiences at the end of training every experience to study forward and backward transfer.

### (i) Data Incremental Digital Pathology Model Update:

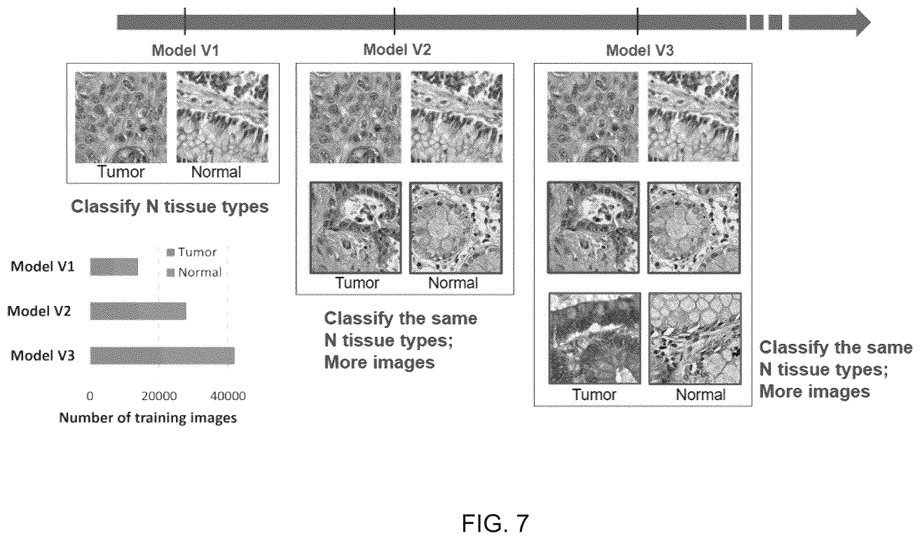

(1.1) The digital pathology scenario: After the initial development of an artificial intelligence-based digital pathology algorithm, more annotated data of the same domain (e.g., small differences and mostly similar; from the same underlying data distribution) may need to be incorporated into the model. In digital pathology settings, expert-annotated and/or expert-validated annotations are time-consuming and may not be available at initial model development, and thus it is common to expect annotated data to arrive in batches. In addition, due to the large number of parameters in artificial intelligence models, especially deep neural networks, it is common to prevent model overfitting by learning from additional data. For example, an initial model may be trained to classify tumor vs. normal tissue from colon cancer images (shown in FIG. 7—plot in the lower left corner illustrates the class label and number of examples at each model version), and then in a subsequent model development/update, similar examples of the same classes may be integrated into the model and such examples arrive in batches over time.
(1.2) Workflow to select best adaptive learning method: (1.2a) To efficiently and effectively update a model without training with existing and newly arrived data from scratch, set up a benchmark dataset from a given digital pathology domain and split data assets randomly into batches, simulating the case of sequentially arriving data. (1.2b) To evaluate how effective the candidate learning methods are in the presence of small random changes in individual examples within each batch, an augmented dataset may be created to simulate such small changes and the image order may be randomly shuffled so that each data batch contains images augmented in different manners. Different types and extents of changes to the original data may be carefully balanced, such that the distribution of the entire dataset is not skewed. Augmentation of the data can be performed dynamically during training or beforehand for each training iteration. Example augmentation techniques include: (i) changing the stain spaces, where initially stain decomposition is performed (e.g., unmixing) and each stain is a then remixed with predefined color vectors to change the hue, saturation and intensities of each stain, (ii) increasing image resolution by resizing an image and then cropping back to the original size, (iii) the like, or (iv) any combination thereof.
(1.3) Artificial intelligence-based methods for adaptive learning: the generated benchmark data batches from (1.2b) may be run for candidate learning methods, such as the following:
(1.3a) Regularization-based methods: these methods mainly focus on prioritizing privacy and reducing memory. The privacy is maintained by avoiding storing raw inputs. Among the different regularization based methods, the two common ones are Elastic Weight Consolidation (EWC) method and the Learning without Forgetting (LWF) method. The EWC is a prior focused method where model parameters are used as prior when learning from new data and the method estimates distribution over the model parameters. The LWF on the other hand, is a data-focused method. The main design of data-focused methods is based on knowledge distillation from the previous model to the current model trained on new data. This concept has also been introduced in LWF where forgetting is handled with the knowledge transfer mechanism. These methods prevent the model from forgetting learned knowledge by applying constraints on the current model weights, so that when updating the current model, the model weights do not deviate too far from its current version.
(1.3b) Replay-based methods: these methods keep the most informative examples or their feature representations (e.g., feature vectors extracted from hidden layers of a neural network) from existing data batches and revisit them during training on newly arrived data. The previous samples of tasks are replayed in the process of learning new tasks in order to overcome forgetting. Among the different methods which fall under this category are—Incremental Learner and Representation Learning (iCaRL), Continual Prototype Evaluation (CoPE), and A-GEM. The iCaRL method stores a subset of best exemplars per class which are chosen according to approximate class means in the learned feature space. The upper bound of this method is determined by the joint training of previous and current tasks. CoPE is an online data incremental learner with prototypes perpetually representing the most salient features of the class population. The rapidly evolving prototypes enable learning and prediction at any point in time. CoPE is robust to class imbalance using replay and balancing memory population scheme. GEM is designed based on a task incremental setting. This method focuses only on new tasks by constraining on their updates and thus does not interfere with previous tasks. This is accomplished by projecting the calculated gradient direction on the feasible region outlined by previous task gradients by first order Taylor series approximation. The A-GEM method is an improved version of the GEM method. A-GEM helps to relax the problem of projecting on one direction estimated by randomly selected samples from a previous task data buffer. A-GEM produces similar performance accuracy as GEM with computation and memory efficiency similar to regularization methods.
(1.3c) Methods that combine regularization and replay.
(1.3d) Methods that leverage meta-learning principles to enable model update with a few examples each batch (See the “CoPE” method implemented in the Experiment section).
(1.3e) Parameter-isolation Methods: These methods assign different model parameters to each task for handling forgetting. There is no fixed architecture for these methods as no constraints are applied to the size of the architecture. So, new branches can grow for new tasks. This can be achieved by freezing previous task parameters or dedicating a model copy to each task. These types of architectures are called dynamic architectures.
(1.3f) Other techniques that are applied together with the aforementioned approaches. For example, perform self-supervised learning for the unlabeled new data before applying the aforementioned methods. As another example, perform adversarial generative models to generate examples similar to these from previous data batches.

### (ii) Domain Incremental Digital Pathology Model Update:

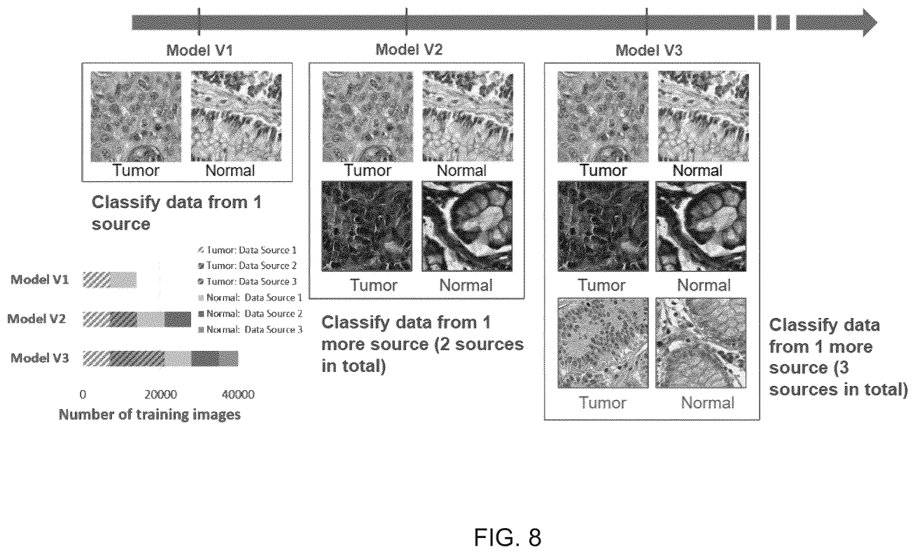

(2.1) The digital pathology scenario: After the initial development of an artificial intelligence-based digital pathology algorithm, annotated data of a different domain (e.g., similar but from a different underlying data distribution) may need to be incorporated into the model. In digital pathology settings, it is a practical need to be able to generate a model robust to changes in the (a) experimental setups, such as changes or differences in (i) staining reagents (ii) staining protocols or instruments, (iii) scanner vendors, (iv) sample sources (e.g. different clinical sites or tissue banks), etc; (b) other aspects, such as tissue type, organ type, patient population, disease stages, disease subtype (e.g. tumor type and subtypes), etc.
(2.2) Workflow to select best adaptive learning method: (2.2a) To efficiently and effectively update a model without training with both existing and newly arrived data from scratch, set up a benchmark dataset from DP domain and generate synthetic images that simulate realistic changes as the data from different sources/domains. (2.2b) To evaluate which candidate adaptive-learning methods are most effective for this scenario, an augmented dataset may be created to simulate multiple types of domain shifts and how well the candidate methods perform with such changes may be evaluated. Augmentation of the data can be performed dynamically during training or beforehand for each training iteration. Example augmentation techniques include: (i) changing the stain spaces, where initially stain decomposition is performed (e.g., unmixing) and each stain is a then remixed with predefined color vectors to change the hue, saturation and intensities of each stain, (ii) increasing image resolution by resizing an image and then cropping back to the original size, (iii) the like, or (iv) any combination thereof. One or multiple types of changes can be applied to each subset, simulating a series of sequential domain shifts. For example, for H&E images with the same tissue types for a classification task, a dataset may be randomly split and the following augmentation subsets may be generated: (i) due to protocol changes, one of the stains becomes more intense (ii) due to aging of the prepared slide, both stains are faded (i.e. reduced stain intensities) (iii) due to change of stainers, one of the stains are more saturated in HSV color space than the other (iv) due to change of scanner, both of the stains change hues in the HSV color space. FIG. 8 illustrates the changes described in (i) and (ii) above (plot in the lower left corner illustrates the class label and number of examples at each model version).
(2.3) Artificial intelligence-based methods for adaptive learning: the generated benchmark data batches from (2.2b) may be run for candidate learning methods, such as the following: (2.3a) Regularization-based methods: these methods prevent the model from forgetting on learned knowledge by applying constraints on the current model weights, so that when updating the current model, the model weights do not deviate too far from its current version. (2.3b) Replay-based methods: these methods keep the most informative examples or their feature representations (e.g. feature vectors extracted from hidden layers of a neural network) from existing data batches and revisit them during training on newly arrived data. (2.3c) Methods that combine regularization and replay. (2.3d) Methods that leverage meta-learning principles to enable model update with a few examples each batch (See the “CoPE” method implemented in the Experiment section). (2.3e) Parameter-isolation Methods. (2.3f) Other techniques that are applied together with the aforementioned approaches. For example, perform self-supervised learning for the unlabeled new data before applying the aforementioned methods. As another example, perform adversarial generative models to generate examples similar to these from previous data batches.
   (iii) Class Incremental Digital Pathology Model Update:
(3.1) The digital pathology scenario: After the initial development of an artificial intelligence-based digital pathology algorithm, there may be a need to expand the model in terms of the number of classes. In digital pathology settings, this scenario is commonly encountered due to reasons such as the follows: (i) the changing needs of end-users, (ii) annotated data come in batches, each batch with a partially or completely different set of classes than these of the existing data and/or (iii) the model design choices, for example, a model initially designed to classify tumor vs. normal and during development it is found that necrosis and lymphocyte clusters needs to be identified to ensure good model performance.
(3.2) Workflow to select best adaptive learning method: (3.2a) To efficiently and effectively update a model without training with both existing and newly arrived data from scratch, a benchmark dataset may be set up from a digital pathology domain and the classes may be split into a number of different subsets, and thus the corresponding examples are split according to their class labels. For example, FIG. 9 illustrates such a class split in each model version (plot in the lower left corner illustrates the class label and number of examples at each model version). (3.2b) Candidate adaptive-learning methods are then evaluated to determine which adaptive-learning methods are most effective for learning the classes in an incremental fashion and the performance of learning a set of different class ordering for each data batch may be compared.
(3.3) Artificial intelligence-based methods for adaptive learning: the generated benchmark data batches from (3.2b) may be run for candidate learning methods, such as the following: (3.3a) Regularization-based methods: these methods prevent the model from forgetting on learned knowledge by applying constraints on the current model weights, so that when updating the current model, the model weights do not deviate too far from its current version. (3.3b) Replay-based methods: these methods keep the most informative examples or their feature representations (e.g. feature vectors extracted from hidden layers of a neural network) from existing data batches and revisit them during training on newly arrived data. (3.3c) Methods that combine regularization and replay. (3.3d) Methods that leverage meta-learning principles to enable model update with a few examples each batch (See the “CoPE” method implemented in the Experiment section). (3.3e) Parameter-isolation Methods. (3.3e) Other techniques that are applied together with the aforementioned approaches. For example, perform self-supervised learning for the unlabeled new data before applying the aforementioned methods. As another example, perform adversarial generative models to generate examples similar to these from previous data batches.

### (iv) Task Incremental Digital Pathology Model Update:

(4.1) In each of the prior described scenarios, a decision may be made on whether to formulate each different data batch as a new task, thus determining whether to apply task-incremental methods. Such methods may specify separate model parts (e.g., separate sets of neurons or separate layers in a neural network model) for each task and at each model iteration, only the model-specific parts are trained, and the rest of the prior trained parts are kept unchanged. Thus, the model can adapt to changing data with separate parts and avoid forgetting the knowledge learned from previous tasks.

### Application of Adaptive Learning Framework to Other Modalities

The adaptive learning framework may be applied to other imaging modalities and other fields of studies. The adaptive learning framework is domain-agnostic from the following aspects. (1) The preconditioning strategies for initial model training can be applied to other types of data, where large numbers of annotations are required to generate an initial model. (2) The three adaptive-learning scenarios of model update/adaptation have commonalities to scenarios encountered in other computational biomedical studies, and thus the adaptive learning method selection strategies can be leveraged by these studies.

The adaptive learning framework may be applied to federated learning. Federated learning aims to update a global model without sharing data from individual data sources and without explicitly sharing local models. The adaptive learning framework can be leveraged by federated learning in the following ways: (1) precondition the local models and/or the global model to enable more effective and efficient model updates with a smaller number of annotations in the target image domain; and (2) update local models and/or the global model via one or multiple of the adaptive learning methods to continuously update models without retraining previous data and select the best learning methods by applying the model selection workflows described herein.

The adaptive learning framework may be applied to multi-model learning. Multimodal learning aims to integrate knowledge learned from different modalities of data. The adaptive learning framework can be leveraged by multi-model learning in the following ways: (1) precondition the models from one or multiple data modalities to enable more effective and efficient model update with a smaller number of annotations in the target image domain; (2) update from one or multiple data modalities via one or multiple of the adaptive learning methods to continuously update model without retraining previous data and select the best learning methods by applying the model selection workflows described herein; and (3) generate a model to integrate the representations from data of multiple modalities in an adaptive fashion, by applying the adaptive learning framework for initial iteration of learning and/or continued updates/adaptation.

### V. Exemplary System for Adaptive Learning

FIG. 10 shows a block diagram that illustrates a computing environment 1000 for processing digital pathology images using an artificial intelligence system (e.g., one or more machine learning models). As further described herein, processing digital pathology images can include using the digital pathology images to train a machine learning algorithm and/or transforming part or all of the digital pathology image into one or more results using a trained (or partly trained) version of the machine learning algorithm (i.e., a machine learning model).

As shown in FIG. 10, computing environment 1000 includes several stages: an image store stage 1005, a pre-processing stage 1010, a labeling stage 1015, a data augmentation stage 1017, a training stage 1020, and a result generation stage 1025.

The image store stage 1005 includes one or more image data stores 1030 (e.g., storage device 430 described with respect to FIG. 4) that are accessed (e.g., by pre-processing stage 1010) to provide a set of digital images 1035 of preselected areas from or the entirety of the biological sample slides (e.g., tissue slides). Each digital image 1035 stored in each image data store 1030 and accessed at image store stage 1010 may include a digital pathology image generated in accordance with part or all of processes described with respect to network 400 depicted in FIG. 4. In some embodiments, each digital image 1035 includes image data from one or more scanned slides. Each of the digital images 1035 may correspond to image data from a single specimen and/or a single day on which the underlying image data corresponding to the image was collected.

The image data may include an image, as well as any information related to color channels or color wavelength channels, as well as details regarding the imaging platform on which the image was generated. For instance, a tissue section may need to be stained by means of application of a staining assay containing one or more different biomarkers associated with chromogenic stains for brightfield imaging or fluorophores for fluorescence imaging. Staining assays can use chromogenic stains for brightfield imaging, organic fluorophores, quantum dots, or organic fluorophores together with quantum dots for fluorescence imaging, or any other combination of stains, biomarkers, and viewing or imaging devices. Example biomarkers include biomarkers for estrogen receptors (ER), human epidermal growth factor receptors 2 (HER2), human Ki-67 protein, progesterone receptors (PR), programmed cell death protein 1 (PD1), and the like, where the tissue section is detectably labeled with binders (e.g., antibodies) for each of ER, HER2, Ki-67, PR, PD1, etc. In some embodiments, digital image and data analysis operations such as classifying, scoring, cox modeling, and risk stratification are dependent upon the type of biomarker being used as well as the field-of-view (FOV) selection and annotations. Moreover, a typical tissue section is processed in an automated staining/assay platform that applies a staining assay to the tissue section, resulting in a stained sample. There are a variety of commercial products on the market suitable for use as the staining/assay platform, one example being the VENTANA® SYMPHONY® product of the assignee Ventana Medical Systems, Inc. Stained tissue sections may be supplied to an imaging system, for example on a microscope or a whole-slide scanner having a microscope and/or imaging components, one example being the VENTANA® iScan Coreo®/VENTANA® DP200 product of the assignee Ventana Medical Systems, Inc. Multiplex tissue slides may be scanned on an equivalent multiplexed slide scanner system. Additional information provided by the imaging system may include any information related to the staining platform, including a concentration of chemicals used in staining, a reaction times for chemicals applied to the tissue in staining, and/or pre-analytic conditions of the tissue, such as a tissue age, a fixation method, a duration, how the section was embedded, cut, etc.

At the pre-processing stage 1010, each of one, more, or all of the set of digital images 1035 are pre-processed using one or more techniques to generate a corresponding pre-processed image 1040. The pre-processing may comprise cropping the images. In some instances, the pre-processing may further comprise standardization or rescaling (e.g., normalization) to put all features on a same scale (e.g., a same size scale or a same color scale or color saturation scale). In certain instances, the images are resized with a minimum size (width or height) of predetermined pixels (e.g., 2500 pixels) or with a maximum size (width or height) of predetermined pixels (e.g., 3000 pixels) and optionally kept with the original aspect ratio. The pre-processing may further comprise removing noise. For example, the images may be smoothed to remove unwanted noise such as by applying a Gaussian function or Gaussian blur.

The pre-processed images 1040 may include one or more training images, validation images, and unlabeled images. It should be appreciated that the pre-processed images 1040 corresponding to the training, validation and unlabeled groups need not be accessed at a same time. For example, an initial set of training and validation pre-processed images 1040 may first be accessed and used to train a machine learning algorithm 1055, and unlabeled input images may be subsequently accessed or received (e.g., at a single or multiple subsequent times) and used by a trained machine learning model 1060 to provide desired output (e.g., cell classification).

In some instances, the machine learning algorithms 1055 are trained using supervised training, and some or all of the pre-processed images 1040 are partly or fully labeled manually, semi-automatically, or automatically at labeling stage 1015 with labels 1045 that identify a “correct” interpretation (i.e., the “ground-truth”) of various biological material and structures within the pre-processed images 1040. For example, the label 1045 may identify a feature of interest (for example) a classification of a cell, a binary indication as to whether a given cell is a particular type of cell, a binary indication as to whether the pre-processed image 1040 (or a particular region with the pre-processed image 1040) includes a particular type of depiction (e.g., necrosis or an artifact), a categorical characterization of a slide-level or region-specific depiction (e.g., that identifies a specific type of cell), a number (e.g., that identifies a quantity of a particular type of cells within a region, a quantity of depicted artifacts, or a quantity of necrosis regions), presence or absence of one or more biomarkers, etc. In some instances, a label 545 includes a location. For example, a label 1045 may identify a point location of a nucleus of a cell of a particular type or a point location of a cell of a particular type (e.g., raw dot labels). As another example, a label 1045 may include a border or boundary, such as a border of a depicted tumor, blood vessel, necrotic region, etc. As another example, a label 1045 may include one or more biomarkers identified based on biomarker patterns observed using one or more stains. For example, a tissue slide stained for a biomarker, e.g., programmed cell death protein 1 (“PD1”), may be observed and/or processed in order to label cells as either positive cells or negative cells in view of expression levels and patterns of PD1 in the tissue. Depending on a feature of interest, a given labeled pre-processed image 1040 may be associated with a single label 1045 or multiple labels 1045. In the latter case, each label 1045 may be associated with (for example) an indication as to which position or portion within the pre-processed image 1045 the label corresponds.

A label 1045 assigned at labeling stage 1015 may be identified based on input from a human user (e.g., pathologist or image scientist) and/or an algorithm (e.g., an annotation tool) configured to define a label 1045. In some instances, labeling stage 1015 can include transmitting and/or presenting part or all of one or more pre-processed images 1040 to a computing device operated by the user. In some instances, labeling stage 1015 includes availing an interface (e.g., using an API) to be presented by labeling controller 1050 at the computing device operated by the user, where the interface includes an input component to accept input that identifies labels 1045 for features of interest. For example, a user interface may be provided by the labeling controller 1050 that enables selection of an image or region of an image (e.g., FOV) for labeling. A user operating the terminal may select an image or FOV using the user interface. Several image or FOV selection mechanisms may be provided, such as designating known or irregular shapes, or defining an anatomic region of interest (e.g., tumor region). In one example, the image or FOV is a whole-tumor region selected on an IHC slide stained with an H&E stain combination. The image or FOV selection may be performed by a user or by automated image-analysis algorithms, such as tumor region segmentation on an H&E tissue slide, etc. For example, a user may select that the image or FOV as the whole slide or the whole tumor, or the whole slide or whole tumor region may be automatically designated as the image or FOV using a segmentation algorithm. Thereafter, the user operating the terminal may select one or more labels 1045 to be applied to the selected image or FOV such as point location on a cell, a positive marker for a biomarker expressed by a cell, a negative biomarker for a biomarker not expressed by a cell, a boundary around a cell, and the like.

In some instances, the interface may identify which and/or a degree to which particular label(s) 1045 are being requested, which may be conveyed via (for example) text instructions and/or a visualization to the user. For example, a particular color, size and/or symbol may represent that a label 1045 is being requested for a particular depiction (e.g., a particular cell or region or staining pattern) within the image relative to other depictions. If labels 1045 corresponding to multiple depictions are to be requested, the interface may concurrently identify each of the depictions or may identify each depiction sequentially (such that provision of a label for one identified depiction triggers an identification of a next depiction for labeling). In some instances, each image is presented until the user has identified a specific number of labels 1045 (e.g., of a particular type). For example, a given whole-slide image or a given patch of a whole-slide image may be presented until the user has identified the presence or absence of three different biomarkers, at which point the interface may present an image of a different whole-slide image or different patch (e.g., until a threshold number of images or patches are labeled). Thus, in some instances, the interface is configured to request and/or accept labels 1045 for an incomplete subset of features of interest, and the user may determine which of potentially many depictions will be labeled.

In some instances, labeling stage 1015 includes labeling controller 1050 implementing an annotation algorithm in order to semi-automatically or automatically label various features of an image or a region of interest within the image. The labeling controller 1050 annotates the image or FOV on a first slide in accordance with the input from the user or the annotation algorithm and maps the annotations across a remainder of the slides. Several methods for annotation and registration are possible, depending on the defined FOV. For example, a whole tumor region annotated on a H&E slide from among the plurality of serial slides may be selected automatically or by a user on an interface such as VIRTUOSO/VERSO™ or similar. Since the other tissue slides correspond to serial sections from the same tissue block, the labeling controller 1050 executes an inter-marker registration operation to map and transfer the whole tumor annotations from the H&E slide to each of the remaining IHC slides in a series. Exemplary methods for inter-marker registration are described in further detail in commonly-assigned and international application WO2014140070A2, “Whole slide image registration and cross-image annotation devices, systems and methods”, filed Mar. 12, 2014, which is hereby incorporated by reference in its entirety for all purposes. In some embodiments, any other method for image registration and generating whole-tumor annotations may be used. For example, a qualified reader such as a pathologist may annotate a whole-tumor region on any other IHC slide, and execute the labeling controller 1050 to map the whole tumor annotations on the other digitized slides. For example, a pathologist (or automatic detection algorithm) may annotate a whole-tumor region on an H&E slide triggering an analysis of all adjacent serial sectioned IHC slides to determine whole-slide tumor scores for the annotated regions on all slides.

At augmentation stage 1017, training sets of images (original images) that are labeled or unlabeled from the pre-processed images 1040 are augmented with synthetic images 1052 generated using augmentation control 1054 executing one or more augmentation algorithms. Augmentation techniques are used to artificially increase the amount and/or type of training data by adding slightly modified synthetic copies of already existing training data or newly created synthetic data from existing training data. As described herein, inter-scanner and inter-laboratory differences may cause intensity and color variability within the digital images. Further, poor scanning may lead to gradient changes and blur effects, assay staining may create stain artifacts such as background wash, and different tissue/patient samples may have variances in cell size. These variations and perturbations can negatively affect the quality and reliability of deep learning and artificial intelligence systems. The augmentation techniques implemented in augmentation stage 1017 may act as a regularizer for these variations and perturbations and help reduce overfitting when training a machine learning model. Example augmentation techniques include (i) changing in the stain spaces, where initially a stain decomposition (e.g., unmixing) is performed and then each stain is remixed with predefined color vectors to change the hue, saturation and intensities of each stain, and (ii) increasing the image resolution by resizing an image and then cropping back to the original size, (iii) the like, or (iv) any combination thereof.

At training stage 1020, labels 1045 and corresponding pre-processed images 1040 can be used by the training controller 1065 to train machine learning algorithm(s) 1055 in accordance with the various workflows described herein. For example, to train an algorithm 1055, the pre-processed images 1040 may be split into a subset of images 1040a for training (e.g., 90%) and a subset of images 1040b for validation (e.g., 10%). The splitting may be performed randomly (e.g., a 90/10% or 70/30%) or the splitting may be performed in accordance with a more complex validation technique such as K-Fold Cross-Validation, Leave-one-out Cross-Validation, Leave-one-group-out Cross-Validation, Nested Cross-Validation, or the like to minimize sampling bias and overfitting. The splitting may also be performed based on the inclusion of augmented or synthetic images 1052 within the pre-processed images 1040. For example, it may be beneficial to limit the number or ratio of synthetic images 1052 included within the subset of images 1040a for training. In some instances, the ratio of original images 1035 to synthetic images 1052 is maintained at 1:1, 1:2, 2:1, 1:3, 3:1, 1:4, or 4:1.

In some instances, the machine learning algorithm 1055 includes a CNN, a modified CNN with encoding layers substituted by a residual neural network (“Resnet”), or a modified CNN with encoding and decoding layers substituted by a Resnet. In other instances, the machine learning algorithm 1055 can be any suitable machine learning algorithm configured to localize, classify, and or analyze pre-processed images 1040, such as a two-dimensional CNN (“2DCNN”), a Mask R-CNN, a U-Net, Feature Pyramid Network (FPN), a dynamic time warping (“DTW”) technique, a hidden Markov model (“HMM”), pure attention-based model, etc., or combinations of one or more of such techniques—e.g., vision transformer, CNN-HMM or MCNN (Multi-Scale Convolutional Neural Network). The computing environment 1000 may employ the same type of machine learning algorithm or different types of machine learning algorithms trained to detect and classify different cells. For example, computing environment 1000 can include a first machine learning algorithm (e.g., a U-Net) for detecting and classifying PD1. The computing environment 500 can also include a second machine learning algorithm (e.g., a 2DCNN) for detecting and classifying Cluster of Differentiation 68 (“CD68”). The computing environment 1000 can also include a third machine learning algorithm (e.g., a U-Net) for combinational detecting and classifying PD1 and CD68. The computing environment 1000 can also include a fourth machine learning algorithm (e.g., a HMM) for diagnosis of disease for treatment or a prognosis for a subject such as a patient. Still other types of machine learning algorithms may be implemented in other examples according to this disclosure.

The training process for the machine learning algorithm 1055 includes selecting hyperparameters for the machine learning algorithm 1055 from the parameter data store 1063, inputting the subset of images 1040a (e.g., labels 1045 and corresponding pre-processed images 1040) into the machine learning algorithm 1055, and performing iterative operations to learn a set of parameters (e.g., one or more coefficients and/or weights) for the machine learning algorithms 1055. The hyperparameters are settings that can be tuned or optimized to control the behavior of the machine learning algorithm 1055. Most algorithms explicitly define hyperparameters that control different aspects of the algorithms such as memory or cost of execution. However, additional hyperparameters may be defined to adapt an algorithm to a specific scenario. For example, the hyperparameters may include the number of hidden units of an algorithm, the learning rate of an algorithm (e.g., 1e-4), the convolution kernel width, or the number of kernels for an algorithm. In some instances, the number of model parameters are reduced per convolutional and deconvolutional layer and/or the number of kernels are reduced per convolutional and deconvolutional layer by one half as compared to typical CNNs.

The subset of images 1040a may be input into the machine learning algorithm 1055 as batches with a predetermined size. The batch size limits the number of images to be shown to the machine learning algorithm 1055 before a parameter update can be performed. Alternatively, the subset of images 1040a may be input into the machine learning algorithm 1055 as a time series or sequentially. In either event, in the instance that augmented or synthetic images 1052 are included within the pre-processed images 1040a, the number of original images 1035 versus the number of synthetic images 1052 included within each batch or the manner in which original images 1035 and the synthetic images 1052 are fed into the algorithm (e.g., every other batch or image is an original batch of images or original image) can be defined as a hyperparameter.

Each parameter is a tunable variable, such that a value for the parameter is adjusted during training. For example, a cost function or objective function may be configured to optimize accurate classification of depicted representations, optimize characterization of a given type of feature (e.g., characterizing a shape, size, uniformity, etc.), optimize detection of a given type of feature, and/or optimize accurate localization of a given type of feature. Each iteration can involve learning a set of parameters for the machine learning algorithms 1055 that minimizes or maximizes a cost function for the machine learning algorithms 1055 so that the value of the cost function using the set of parameters is smaller or larger than the value of the cost function using another set of parameters in a previous iteration. The cost function can be constructed to measure the difference between the outputs predicted using the machine learning algorithms 1055 and the labels 1045 contained in the training data. For example, for a supervised learning-based model, the goal of the training is to learn a function “h( )” (also sometimes referred to as the hypothesis function) that maps the training input space X to the target value space Y, h: X→Y, such that h (x) is a good predictor for the corresponding value of y. Various different techniques may be used to learn this hypothesis function. In some techniques, as part of deriving the hypothesis function, the cost or loss function may be defined that measures the difference between the ground truth value for an input and the predicted value for that input. As part of training, techniques such as back propagation, random feedback, Direct Feedback Alignment (DFA), Indirect Feedback Alignment (IFA), Hebbian learning, and the like are used to minimize this cost or loss function.

The training iterations continue until a stopping condition is satisfied. The training-completion condition may be configured to be satisfied when (for example) a predefined number of training iterations have been completed, a statistic generated based on testing or validation exceeds a predetermined threshold (e.g., a classification accuracy threshold), a statistic generated based on confidence metrics (e.g., an average or median confidence metric or a percentage of confidence metrics that are above a particular value) exceeds a predefined confidence threshold, and/or a user device that had been engaged in training review closes a training application executed by the training controller 1065. Once a set of model parameters are identified via the training, the machine learning algorithms 1055 has been trained and the training controller 1065 performs the additional processes of testing or validation using the subset of images 1040b (testing or validation data set). The validation process may include iterative operations of inputting images from the subset of images 1040b into the machine learning algorithm 1055 using a validation technique such as K-Fold Cross-Validation, Leave-one-out Cross-Validation, Leave-one-group-out Cross-Validation, Nested Cross-Validation, or the like to tune the hyperparameters and ultimately find the optimal set of hyperparameters. Once the optimal set of hyperparameters are obtained, a reserved test set of images from the subset of images 1040b are input the machine learning algorithm 1055 to obtain output, and the output is evaluated versus ground truth using correlation techniques such as Bland-Altman method and the Spearman's rank correlation coefficients and calculating performance metrics such as the error, accuracy, precision, recall, receiver operating characteristic curve (ROC), etc. In some instances, new training iterations may be initiated in response to receiving a corresponding request from a user device or a triggering condition (e.g., initial model development, model update/adaptation, continuous learning, drift is determined within a trained machine learning model 1060, and the like).

As should be understood, other training/validation mechanisms are contemplated and may be implemented within the computing environment 1000. For example, the machine learning algorithm 1055 may be trained and hyperparameters may be tuned on images from the subset of images 1040a and the images from the subset of images 1040b may only be used for testing and evaluating performance of the machine learning algorithm 1055. Moreover, although the training mechanisms described herein focus on training a new machine learning algorithm 1055. These training mechanisms can also be utilized for initial model development, model update/adaptation, and continuous learning of existing machine learning models 1060 trained from other datasets, as described in detail herein. For example, in some instances, machine learning models 1060 might have been preconditioned using images of other objects or biological structures or from sections from other subjects or studies (e.g., human trials or murine experiments). In those cases, the machine learning models 1060 can be used for initial model development, model update/adaptation, and continuous learning using the pre-processed images 1040.

The trained machine learning model 1060 can then be used (at result generation stage 1025) to process new pre-processed images 1040 to generate predictions or inferences such as predict cell centers and/or location probabilities, classify cell types, generate cell masks (e.g., pixel-wise segmentation masks of the image), predict a diagnosis of disease or a prognosis for a subject such as a patient, or a combination thereof. In some instances, the masks identify a location of depicted cells associated with one or more biomarkers. For example, given a tissue stained for a single biomarker the trained machine learning model 1060 may be configured to: (i) infer centers and/or locations of cells, (ii) classify cells based on features of a staining pattern associated with the biomarker, and (iii) output a cell detection mask for the positive cells and a cell detection mask for the negative cells. By way of a another example, given a tissue stained for two biomarkers the trained machine learning model 1060 may be configured to: (i) infer centers and/or locations of cells, (ii) classify cells based on features of staining patterns associated with the two biomarkers, and (iii) output a cell detection mask for cells positive for the first biomarker, a cell detection mask for cells negative for the first biomarker, a cell detection mask for cells positive for the second biomarker, and a cell detection mask for cells negative for the second biomarker. By way of another example, given a tissue stained for a single biomarker the trained machine learning model 1060 may be configured to: (i) infer centers and/or locations of cells, (ii) classify cells based on features of cells and a staining pattern associated with the biomarker, and (iii) output a cell detection mask for the positive cells and a cell detection mask for the negative cells code, and a mask cells classified as tissue cells.

In some instances, an analysis controller 1080 generates analysis results 1085 that are availed to an entity that requested processing of an underlying image. The analysis result(s) 1085 may include the masks output from the trained machine learning models 1060 overlaid on the new pre-processed images 1040. Additionally, or alternatively, the analysis results 1085 may include information calculated or determined from the output of the trained machine learning models such as whole-slide tumor scores. In exemplary embodiments, the automated analysis of tissue slides use the assignee VENTANA's FDA-cleared 510(k) approved algorithms. Alternatively, or in addition, any other automated algorithms may be used to analyze selected regions of images (e.g., masked images) and generate scores. In some embodiments, the analysis controller 1080 may further respond to instructions of a pathologist, physician, investigator (e.g., associated with a clinical trial), subject, medical professional, etc. received from a computing device. In some instances, a communication from the computing device includes an identifier of each of a set of particular subjects, in correspondence with a request to perform an iteration of analysis for each subject represented in the set. The computing device can further perform analysis based on the output(s) of the machine learning model and/or the analysis controller 1080 and/or provide a recommended diagnosis/treatment for the subject(s).

It will be appreciated that the computing environment 1000 is exemplary, and the computing environment 1000 with different stages and/or using different components are contemplated. For example, in some instances, a network may omit pre-processing stage 1010, such that the images used to train an algorithm and/or an image processed by a model are raw images (e.g., from image data store). As another example, it will be appreciated that each of pre-processing stage 1010 and training stage 1020 can include a controller to perform one or more actions described herein. Similarly, while labeling stage 1015 is depicted in association with labeling controller 1050 and while result generation stage 1025 is depicted in association with analysis controller 1080, a controller associated with each stage may further or alternatively facilitate other actions described herein other than generation of labels and/or generation of analysis results. As yet another example, the depiction of computing environment 1000 shown in FIG. 10 lacks a depicted representation of a device associated with a programmer (e.g., that selected an architecture for machine learning algorithm 1055, defined how various interfaces would function, etc.), a device associated with a user providing initial labels or label review (e.g., at labeling stage 1015), and a device associated with a user requesting model processing of a given image (which may be a same user or a different user as one who had provided initial labels or label reviews). Despite the lack of the depiction of these devices, computing environment 1000 may involve the use one, more or all of the devices and may, in fact, involve the use of multiple devices associated with corresponding multiple users providing initial labels or label review and/or multiple devices associated with corresponding multiple users requesting model processing of various images.

### VI. Techniques for Training a Machine Learning Algorithm Using an Adaptive Learning Framework

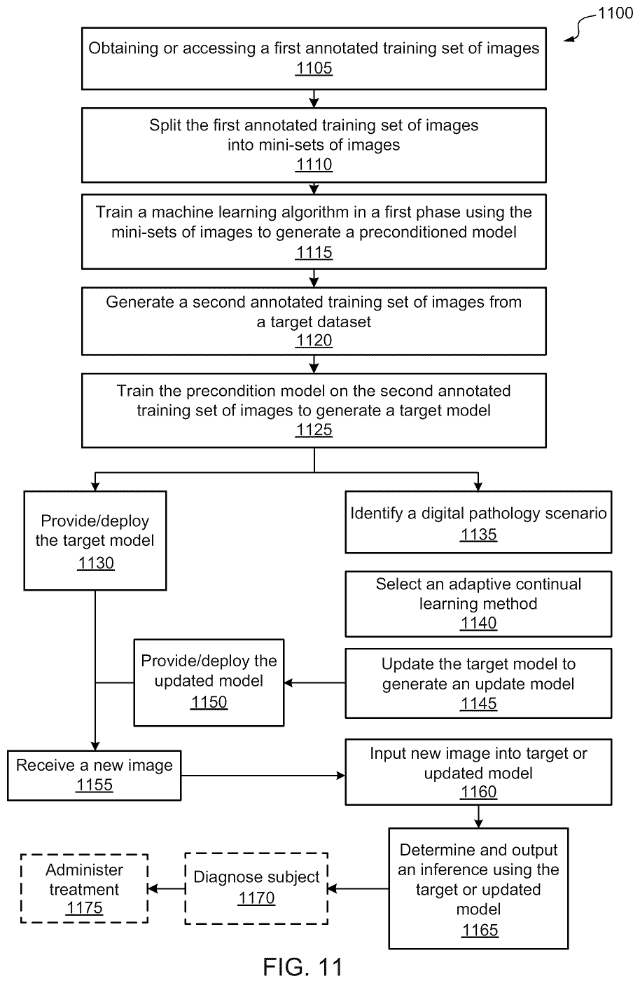

FIG. 11 shows a flowchart illustrating a process 1100 for using a training set of images to train a machine learning algorithm in accordance with various embodiments. The process 1100 depicted in FIG. 11 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 1100 presented in FIG. 11 and described below is intended to be illustrative and non-limiting. Although FIG. 11 depicts the various processing steps occurring in a particular sequence or order, this is not intended to be limiting. In certain alternative embodiments, the steps may be performed in some different order or some steps may also be performed in parallel. In certain embodiments, such as in the embodiments depicted in FIGS. 4 and 10, the processing depicted in FIG. 11 may be performed by as part of the training stage (e.g., algorithm training 1020) to train a machine learning algorithm using a training set of images to generate a machine learning model configured to detect, characterize, classify, or a combination thereof some or all regions or objects within images.

Process 1100 starts at block 1105, at which a first annotated training set of images are obtained for training a machine learning algorithm to detect, characterize, classify, or a combination thereof some or all regions or objects within the images. The first annotated training set of images are in a first image domain (e.g., pre-processed images 1040 of computing environment 1000 described with respect to FIG. 10). In some instances, the first annotated training set of images are digital pathology images comprising one or more types of cells. The first annotated training set of images may depict cells having a staining pattern associated with a biomarker. In some instances, first annotated training set of images depict cells having multiple staining patterns associated with multiple biomarkers. The first annotated training set of images may be annotated with labels for training (e.g., supervised, semi-supervised or weakly-supervised).

At block 1110, the first annotated training set of images are split into mini-sets of images each mini-set representing a distinct modeling subtask and comprising a limited number of examples. In some instances, the splitting comprises: when only one mini-set of images is available, for each distinct modeling subtask, select a subset of classes to be a part of or match the number of classes being trained on in the second phase and select the limited number of examples based on the selected subset of classes; and when multiple mini-sets of images are available, for each distinct modeling subtask, either: (i) mix examples from the multiple mini-set of images, select a subset of classes to be a part of or match the number of classes being trained on in the second phase, and select the limited number of examples from the mixed examples based on the selected subset of classes, or (ii) select a mini-set of images from the multiple mini-set of images, select a subset of classes to be a part of or match the number of classes being trained on in the second phase, and select the limited number of examples from the selected mini-set of images based on the selected subset of classes.

At block 1115, the machine learning algorithm is trained in a first phase using the mini-sets of images to generate a preconditioned machine learning model configured to detect, characterize, classify, or a combination thereof some or all regions or objects within new images. In some instances, the first phase further comprises: an inner learning-loop, wherein the machine learning algorithm updates model weights or parameters on one subtask with a predefined or flexible number of epochs for initializing the preconditioned machine learning model for adaption to the target dataset, which generates a loss for a validation set of images after model update, denoted as L-subtask-i for the ith-subtask; and an outer learning-loop, wherein an objective is to search for a set of model initializations that generates the preconditioned machine learning model when used for updating all subtasks, each with only the limited number of examples, by finding a model initialization that minimizes a sum of all loss, denoted as summing up L-subtask-i, with i ranging from 1 to a number of subtasks calculated from validation sets of images of the subtasks with respect to the model initialization.

In some instances, the training of the first phase comprises performing iterative operations to learn a set of parameters to detect, characterize, classify, or a combination thereof some or all regions or objects within the mini-sets of images that maximizes or minimizes a cost function, wherein each iteration involves finding the set of parameters for the machine learning algorithm so that a value of the cost function using the set of parameters is larger or smaller than a value of the cost function using another set of parameters in a previous iteration, and wherein the cost function is constructed to measure a difference between predictions made for some or all the regions or the objects using the machine learning algorithm and ground truth labels provided for the mini-sets of images.

At block 1120, a limited number of images from a target dataset is labeled to generate a second annotated training set of images for training a machine learning algorithm to detect, characterize, classify, or a combination thereof some or all regions or objects within the images. The second annotated training set of images are in a second image domain (different from the first image domain). In certain instances, the limited number of images is less than 50 images, 30 images or 20 images.

At block 1125, the preconditioned machine learning model is trained in a second phase using the second annotated training set of images to generate a target machine learning model configured to detect, characterize, classify, or a combination thereof some or all regions or objects within the new images. A number of classes being trained on in the first phase are a part of or match the number of classes being trained on in the second phase. In some instances, the second phase further comprises: applying the preconditioned machine learning model to generate a feature vector representation for each example within the second annotated training set of images; combining the feature vector representations from examples of a same class to generate one representation per target class, use one representation per target class as prototypes for target classes; generating feature vector representations for images or image regions of a remainder of unlabeled images from the target dataset; and comparing each feature vector representation from the unlabeled images with the prototypes for target classes based on a distance between the feature vector representation from the unlabeled images and the prototypes for target classes.

In some embodiments, the training of the second phase comprises performing iterative operations to learn a set of parameters to detect, characterize, classify, or a combination thereof some or all regions or objects within the second annotated training set of images that maximizes or minimizes a cost function, wherein each iteration involves finding the set of parameters for the preconditioned machine learning model so that a value of the cost function using the set of parameters is larger or smaller than a value of the cost function using another set of parameters in a previous iteration, and wherein the cost function is constructed to measure a difference between predictions made for some or all the regions or the objects using the preconditioned machine learning model and ground truth labels provided for the second annotated training set of images.

At optional block 1130, the target machine learning model is provided. For example, the target machine learning model may be deployed for execution in an image analysis environment, as described with respect to FIG. 10.

At block 1135, a digital pathology scenario is identified. The digital pathology scenario may be a data incremental scenario, a domain incremental scenario, class incremental scenario, or a task incremental scenario.

At block 1140, an adaptive continual learning method is selected for updating the target machine learning model given the digital pathology scenario. In some instances, the adaptive continual learning method is selected from the group comprising: Elastic Weight Consolidation (EWC), Learning without Forgetting (LWF), Incremental Learner and Representation Learning (iCaRL), Continual Prototype Evaluation (CoPE), A-GEM, and a parameter isolation method. In other instances, the adaptive continual learning method includes: EWC, LWF, iCaRL, CoPE, A-GEM, a parameter isolation method, a like continuous learning method, or any combination thereof.

At block 1145, the target machine learning model is updated based on the adaptive continual learning method to generate an updated machine learning model.

At optional block 1150, the updated machine learning model is provided. For example, the updated machine learning model may be deployed for execution in an image analysis environment, as described with respect to FIG. 10.

At block 1155, a new image is received. The new image may be divided into image patches of a predetermined size. For example, whole-slide images typically have random sizes and a machine learning algorithm such as a modified CNN learns more efficiently (e.g., parallel computing for batches of images with the same size; memory constraints) on a normalized image size, and thus the image may be divided into image patches with a specific size to optimize analysis. In some embodiments, the image is split into image patches having a predetermined size of 64 pixels×64 pixels, 128 pixels×128 pixels, 256 pixels×256 pixels, or 512 pixels×512 pixels.

At block 1160, the new image or the image patches are input into the target machine learning model or the updated machine learning model. At block 1165, the target machine learning model or the updated machine learning model detects, characterizes, classifies, or a combination thereof some or all regions or objects within the new image or the image patches, and outputs an inference based on the detecting, characterizing, classifying, or a combination thereof.

At optional block 1170, a diagnosis of a subject associated with the image or the image patches is determined based on the inference output by the revised machine learning model.

At optional block 1175, a treatment is administered to the subject associated with the image or the image patches. In some instances, the treatment is administered based on (i) inference output by the machine learning model or the revised machine learning model, and/or (ii) the diagnosis of the subject determined at block 1170.

### VII. EXAMPLES

The systems and methods implemented in various embodiments may be better understood by referring to the following examples.

### Data

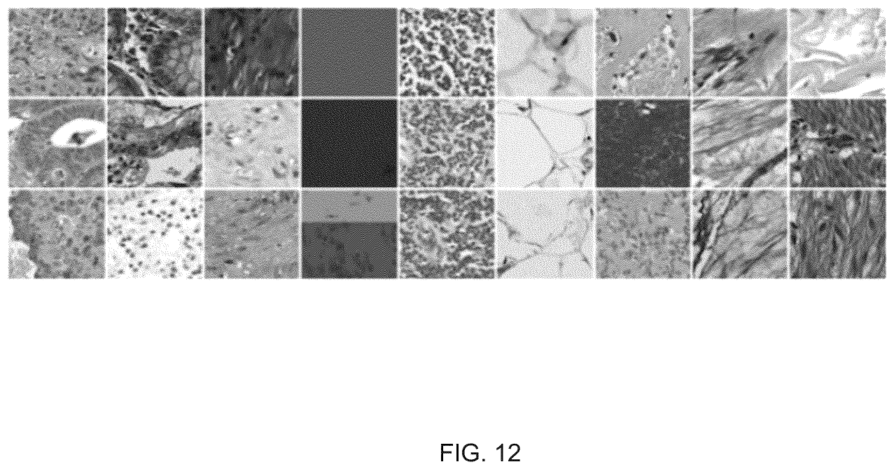

CRC: The following experiments used 100,000 non-overlapping patches from H&E stained histological images of human colorectal cancer (CRC) composed of nine tissue classes including Adipose (ADI), background (BACK), debris (DEB), lymphocytes (LYM), mucus (MUC), smooth muscle (MUS), normal colon mucosa (NORM), cancer-associated stroma (STR), colorectal adenocarcinoma epithelium (TUM) for training. Some example images are shown in FIG. 12. The test set comprised 7180 image patches with no overlap with the training data. All images were color normalized using Macenko's method.

The CRC dataset was augmented by varying stain intensity, color and saturation individually and in combination to simulate data collected from different stainers, scanners and chromogens. The images were unmixed using non-negative matrix factorization. Four settings of color, saturation and intensity were applied to individual stains from non-overlapping subsets of the original dataset. Each synthetic setting, in conjunction with the original dataset, was used to create different adaptive learning scenarios.
1. Each augmentation setting was perceived as a shift in domain from the original dataset. The dataset can thus be divided into five data streams each representing a different augmentation or domain setting resulting in a five-experience domain incremental scenario (five was used in the experiments disclosed herein but it should be understood that the dataset could be split into any number “n” data streams each representing a different augmentation or domain setting resulting in a “n”-experience domain incremental scenario). The model learns to classify images in a new domain setting with every experience the model was trained on.
2. The different augmentations were also be mixed together uniformly across classes. This mixed dataset was used to create five data streams or experiences of equal sizes with representations from all classes (five was used in the experiments disclosed herein but it should be understood that the dataset could be split into any number “n” data streams or experiences of equal sizes with representations from all classes). This constitutes a data incremental scenario where each subsequent experience adds to the training data for the model.
3. The uniformly mixed dataset was also split into subsets or experiences each containing different classes to form a class incremental scenario. Depending on how the data is split, the model was exposed to different classes in each experience and was trained on all classes at the training process.

Continual learning scenarios: Each synthetic setting, in conjunction with the original dataset, can be used to create different continual learning scenarios. Each augmentation setting is a shift in domain from the original dataset. They were used separately as individual data streams or experiences in a domain incremental set up. Images from the different augmentation settings were mixed together uniformly across classes and divided into experiences with equal class representation to constitute a data incremental scenario. The uniformly mixed dataset was also split into experiences each containing different classes to form a class incremental scenario.

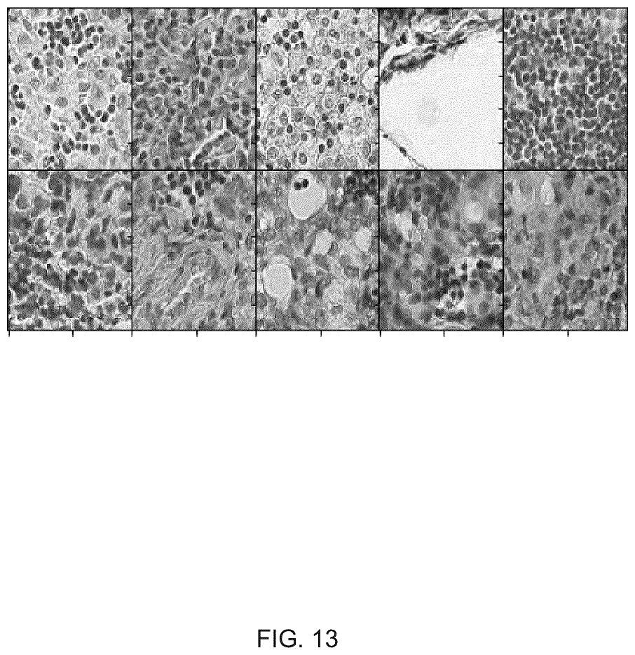

PatchCam: The PatchCam benchmark dataset comprised of 327,680 patches extracted from 400 H&E stained whole slide images of lymph node sections from breast tissue at a size of 96×96 pixels @ 10× magnification, with a 75/12.5/12.5% train/validate/test split, selected using a hard-negative mining regime. The dataset has two classes—normal and tumor—to indicate the presence of metastatic tissue. This dataset was also normalized using Macenko's method for consistency with the CRC dataset and easy comparison. Normalized examples from both classes are shown in FIG. 13. The top row includes samples from the normal class and the bottom row contains examples from the tumor class.

Continual learning scenario: A dramatic domain shift in data streams was evaluated by training a model with the original CRC images (stain normalized) in the first experience and the normalized PatchCam dataset in the second experience.

### Methods

The following continual learning methods were experimented with to handle the three scenarios: EWC and online EWC, LwF, iCaRL, CoPE and A-GEM. All the methods were compared against two baselines: 1) training from scratch (upper bound), where the same network architecture, an 18-layer ResNet, was trained on all the data available from all the experiences seen so far., and 2) transfer learning or fine tuning (i.e., lower bound), where the model was trained with the same design as continual learning with exposure to only the data available during a particular experience but instead of using a strategy to alleviate forgetting, the model was just fine tuned to adapt to the new classes. Training epochs were set to be 15 and a batch size of 16 for all experiments. The same ResNet architecture was used with a multi-headed setup with each head used for a different task when testing with A-GEM as per their findings. A Stochastic Gradient Descent optimizer was used starting with a learning rate of 0.1, momentum of 0.9, and a weight decay of 0.00001 applied after epochs 10 and 13.

### Example 1

### Data Incremental Setup

The first experiment involved the data incremental scenario in which more data is sequentially fed to the model which then gets updated based on only the most recent data without access to any of the older datasets on which it was previously trained. Newer data streams would still have the same classes as the older streams but might have a shift in distribution. The mixed dataset used in this experiment should have a uniform distribution between the experiences.

A method called continual prototype evaluation (CoPE) was used to train the model with this setup. CoPE is an online data incremental algorithm which uses prototypes to represent the most important features from the data. The prototypes evolve continuously as the model learns to keep up with data changes and can make predictions accurately. CoPE also incorporates balanced replay to make sure all classes are well represented in the replay population. The data was fed as mini batches or mini experiences in an online fashion, that is the model sees each data sample only once and is hence trained with a single epoch. A mini experience size of 128 samples (i.e., each mini experience had only 128 samples) was used for training with a batch size of 10 and a momentum of 0.99 to reduce forgetting. Thus, for the data incremental scenario created for the augmented dataset, each of the 5 experiences has 99 mini experiences.

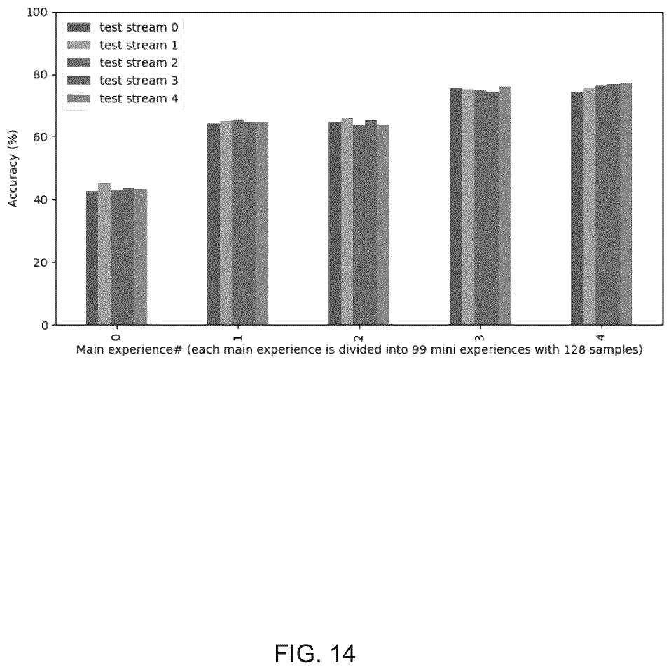

At the end of training, the test streams with samples from the different experiences had an average accuracy of 76%. FIG. 14 shows accuracy of test streams at the end of each main experience under a data incremental setup with the augmented CRC dataset using CoPE. Experiences were split with a user-defined size of 128 images resulting in 99 mini-experiences within each experience which are fed to the model in an online fashion. The numbers shown in the plot were at the end of every 99th mini experience or every main experience. The accuracy of classification progressively increased showing that the model benefitted from more data. Accuracy of individual test streams also increased as the model learned from newer training streams indicating the model was not forgetting what it had learned previously. Equal representation from all synthetic domains in each experience resulted in transfer learning and test streams benefiting from all of the data. It is also worth noting that the model performed just as well on test streams from subsequent experiences. For example, at the end of main experience 1, the model performed similarly on test stream 1 as well as test streams 2, 3 and 4 indicating some transfer learning. The mixed augmented dataset used here has equal representation from all synthetic domains resulting in similar distributions between experiences. Accuracy also improved by less than 1% between experiences 3 and 4 indicating the model performed just as well with 80% of the data.

### Example 2

### Domain Incremental Setup

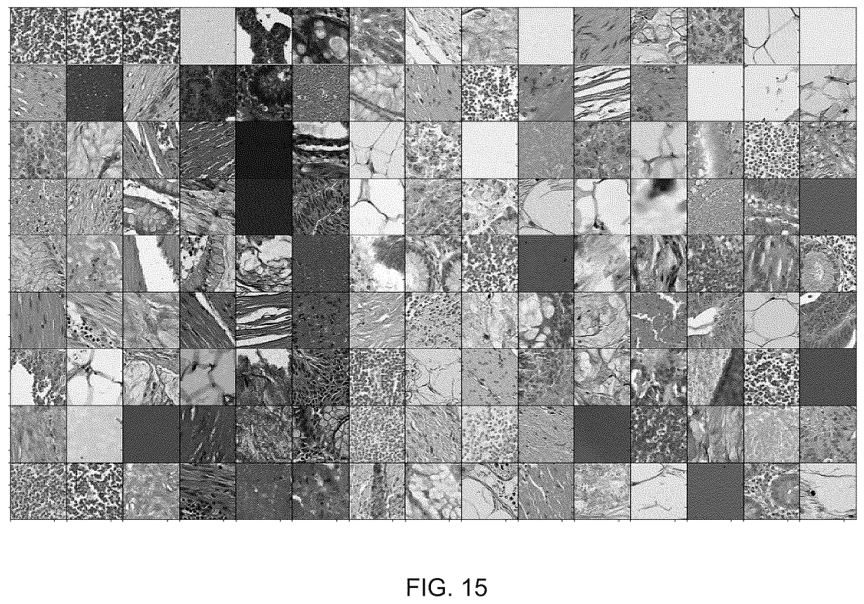

The second experiment was with the domain incremental scenario with 5 experiences with hue, saturation and intensity values of the two stains—eosin and hematoxylin—varied by different degrees mimicking images acquired with different stainers, scanners and reagents. Examples from the 5 experiences are shown in FIG. 15. Each row corresponds to one of the nine tissue types and three example images are plotted from each augmentation setting (i.e. domain). Domain 0 (Columns 1-3): stain-normalized CRC dataset. Domain 1 (Columns 4-6): increased eosin stain intensities, simulating the scenario of increased concentration of eosin solution or elongated staining time. Domain 2 (Columns 7-9): reduced eosin intensity, simulating the scenario of aged slides with faded stains. Domain 3 (Columns 10-12): differentially changed hues of hematoxylin and eosin. Domain 4 (Column 13-15): changed hue and increased levels of saturation to both eosin and hematoxylin. Each of the three column sections can be considered as separate domains in a domain incremental scenario. The domains can be mixed up and each divided into experiences with representations from all classes for a data incremental scenario or be split into mixed domain experiences each with a non-overlapping subset of classes for a class incremental scenario.

A method called Learning without Forgetting (LwF) was employed for this scenario. LwF is a combination of finetuning and distillation. LwF learns task-specific parameters for the new/current task without compromising performance on old tasks using only the latest data corresponding to the current task. Unlike traditional regularization which penalizes changes in parameters based on its importance, LwF penalizes changes to mapping from input to output. The loss function is comprised of two terms-a cross entropy loss for the current task and a distillation loss to prevent previously acquired knowledge from being forgotten.

LwF performed well on 3 of the 5 predefined domains with accuracy of over 86%. Though evaluation accuracy was at 88% and 93% for domains 1 and 2 respectively during experiences the model was trained on the corresponding domains, knowledge retention was unsatisfactory. There was however nearly 28% forgetting of the acquired domain-specific knowledge especially with domains 1 and 2 when the specific domain data was no longer available.

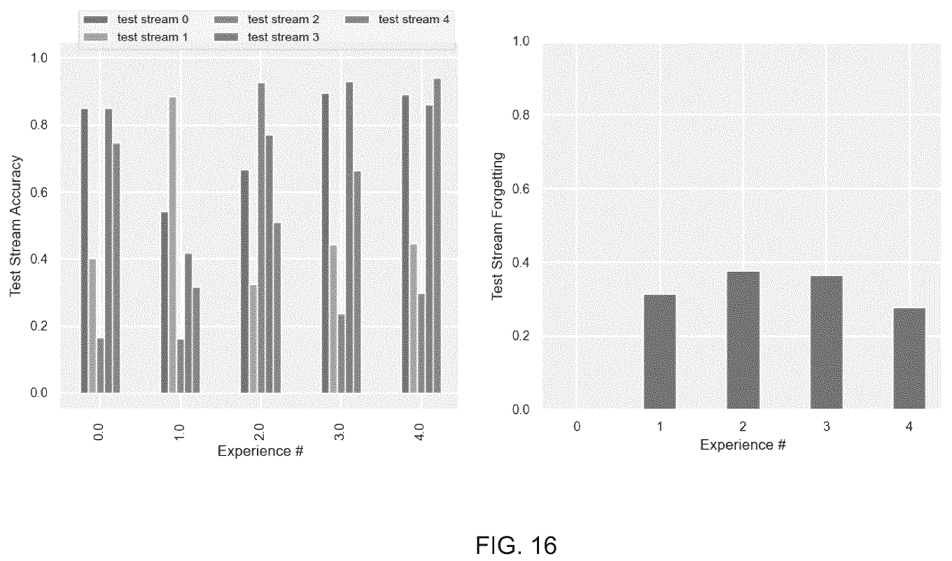

Results are shown in FIG. 16, accuracy (left) and forgetting (right) of test streams at the end of each main experience under a domain incremental setup with the augmented CRC dataset using LwF. At the end of training, the model performed with an accuracy of 86-94% on 3 of the 5predefined domains. Though the model performed well on domain 1 (88%) and domain 2 (93%), the acquired domain-specific knowledge was forgotten during subsequent experiences when the specific domain data was no longer available. The test stream forgetting metric was at ˜28% at the end of training indicating accuracy loss from domains 1 and 2 over the course of training. This experiment demonstrated that a model presented with data from different domains in successive data streams can be trained to adapt reasonably well to a new domain while still maintaining performance in previous domains to which it no longer has access.

### Example 3

### Class Incremental Setup

In the third experiment, a model was trained with a class incremental setup as described herein with 3 experiences and 6 classes such that the model had access to data from only two classes during each experience and newer classes were added progressively at each experience. Incremental Class & Representation Learning (iCaRL) was the adaptive learning strategy used here. iCaRL chooses exemplars from data streams dynamically and each class has its own exemplar set. iCaRL updates both parameters and exemplars as it sees new data. iCaRL performs classification by the nearest mean of exemplars. iCaRL involves representation learning with distillation and prototype rehearsal where the augmented dataset comprised data from the current task and stored exemplars and model parameters were updated based on cross entropy loss for the newer classes and distillation loss of the previously learned classes.

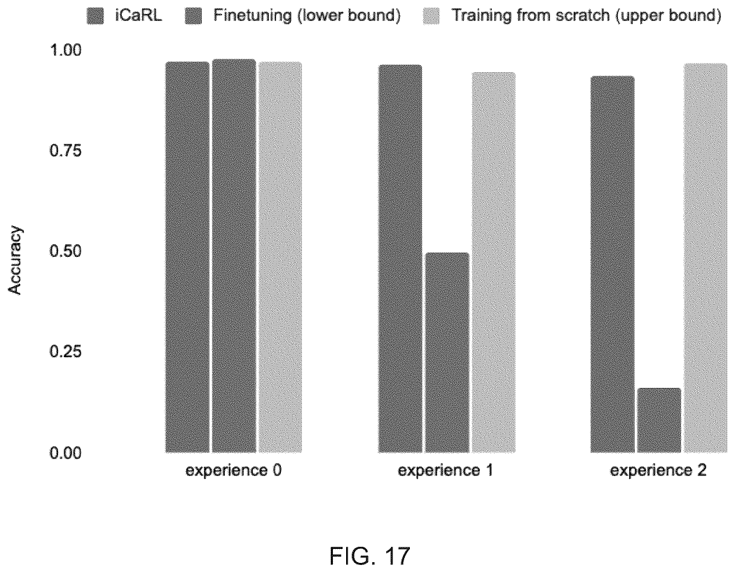

There were two baselines the iCaRL algorithm was compared with—1) training from scratch where the same neural net was trained on all the data available until a specific experience (upper bound). That is, the iCaRL algorithm was trained on two classes during the first experience, four classes during the second and all six classes during the third., and 2) transfer learning or fine tuning (lower bound) where the model was trained with the same design as adaptive learning with exposure to only two classes during each of the 3 experiences but instead of using a strategy to alleviate forgetting, the model was just fine tuned to adapt to the newer classes. Results are shown in FIG. 17. As shown, it was observed that iCaRL performs on par with the upper bound of training from scratch which utilizes only a fraction of the data thus providing a significant computational advantage as well. Transfer learning performed well on experience 0 but with exposure and learning of newer classes, forgot previously acquired knowledge. Though computationally comparable to iCaRL, transfer learning performance was unsatisfactory with catastrophic forgetting.

### Example 4

### Comparison of Methods

Continual learning with the augmented CRC dataset. For a fair comparison, the domain and data incremental experiments had 5 experiences and class incremental experiments had 4 experiences with the first three experiences having 2 classes each and the last experience having the remaining 3 classes. A-GEM was found to provide best results with a task descriptor hence it was treated as a task incremental method with each experience introducing a new set of classes to the model with a task ID. Hyperparameters for each method were determined through grid search. CoPE and A-GEM were treated as online, few shot methods and trained with only 1 epoch. iCaRL was experimented with in three settings. The first setting had 4 experiences with the first three having 2 classes each and the last experience having the remaining three classes. The second setting also had 4 experiences but had 3 classes in the first experience and the remaining experiences had 2 classes each. The final setting had 3 experiences, each with 3 classes. The class order was the same across the settings and was in ascending order. LwF was experimented with for continually learning the original CRC dataset and the normalized PatchCam dataset in a domain incremental setting, where one tumor type is considered as one domain.

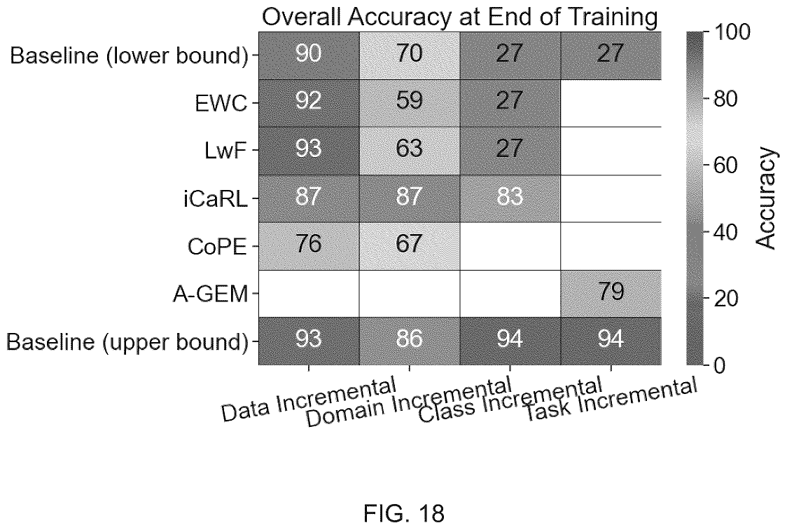

Evaluation accuracy at the end of training for the three designed scenarios—data, domain and class incremental-for the continuous learning methods are shown in FIG. 18. In data and domain incremental scenarios, LwF and iCaRL were comparable to the upper bound baseline. Class incremental scenario was a more difficult task to learn overall. iCaRL had the highest accuracy at 83%. A-GEM was the only method tested and evaluated with a task incremental scenario.

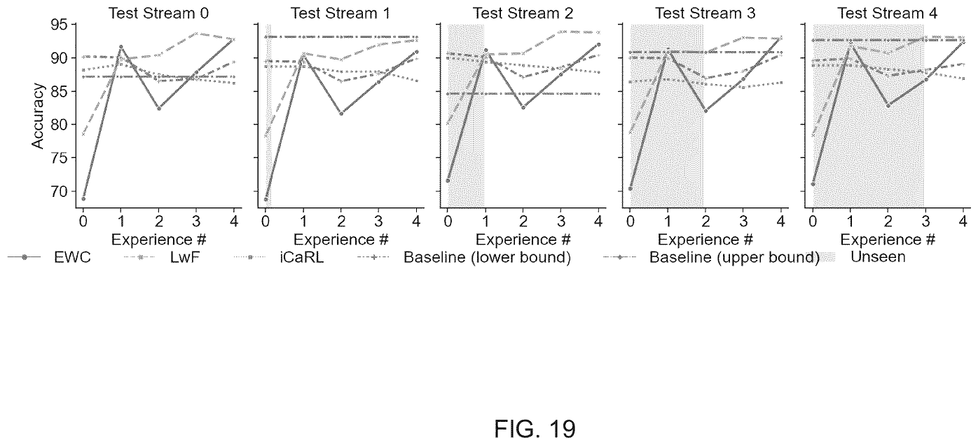

Data incremental scenario: LwF had an overall accuracy of 93% at the end of training with <1% forgetting of previously gained knowledge. This was 4% better than the lower bound and within 0.5% of upper baseline. Per-experience accuracy numbers are shown in FIG. 19. Specifically, FIG. 19 shows data incremental experiences tested with different CL methods as listed in the legend including two baselines. Each experience is comprised of its own test stream containing examples from a smaller batch of data belonging exclusively to the experience. Each subplot shows how the model performed on a test stream evaluated at the end of training on all experiences. The gray regions show the experiences the model has not yet been trained on, where the model is expected to perform less well on these experiences. However, once it has been trained on a particular experience, it should ideally not forget what it has learnt and retain the knowledge through the rest of the training process-that is, accuracy should remain high in the non-grayed out region for all test streams. LwF had the highest overall accuracy at the end of training.

The accuracy of classification progressively increased showing that the model benefitted from more data. Accuracy of individual test streams also increased as the model learned from newer training streams indicating the model was not forgetting what it had learned previously. Another observation is the performance of the iCaRL method. iCaRL was designed as a class incremental method but the concept of storing exemplars representative of classes in each domain should theoretically have worked better than EWC and LwF. It is possible that the maximum memory size tested is not sufficient to store not just “n” classes as in class incremental but store “n” classes times “d” domains.

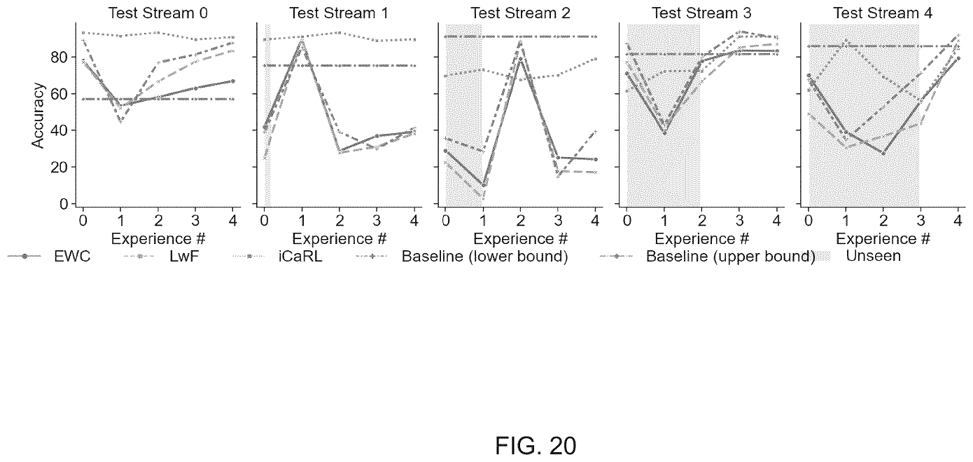

Domain incremental scenario: As shown in FIG. 20, iCaRL performed better than EWC and LwF with the best hyperparameters selected from grid search. As shown in FIG. 20, 5 domain incremental experiences were tested with different CL methods as listed in the legend including two baselines. Each experience comprised of its own test stream containing examples from a domain belonging exclusively to the experience. Each subplot shows how the model performed on a test stream evaluated at the end of training on all experiences. The gray regions show the experiences the model has not yet been trained on, where the model is expected to perform less well on these experiences. However, once it has been trained on a particular experience, it should ideally not forget what it has learnt and retain the knowledge through the rest of the training process—that is, accuracy should remain high in the non-grayed out region for all test streams. It can be seen that iCaRL is comparable to the upper bound baseline while the performances of EWC and LwF were closer to the lower bound baseline. Note that the upper bound is low in the first experience (an accuracy of 0.57), due to the small number of training examples (20% of the total examples).

It is interesting to note that: 1) the model retained knowledge from some domains better than others. Specifically, it is more challenging to retain learned knowledge on datasets with increased (Domains 1; Column 4-6 in FIG. 15) or decreased (Domains 2; Column 7-9 in FIG. 15) eosin intensities, whereas changes in hue and/or saturation of the stains (Domain 3 & Domain 4) did not in FIG. 15) There was some transfer learning between domains. Even after training on just Domain 0, the model performed well on the test stream corresponding to Domain 4. The performance of these two domains remained high at the end of the training process as well. As the fourth domain was generated with hue changes to the stains, these results suggest that the models can handle a range of hue changes in continually learning and retaining knowledge from sequential data streams.

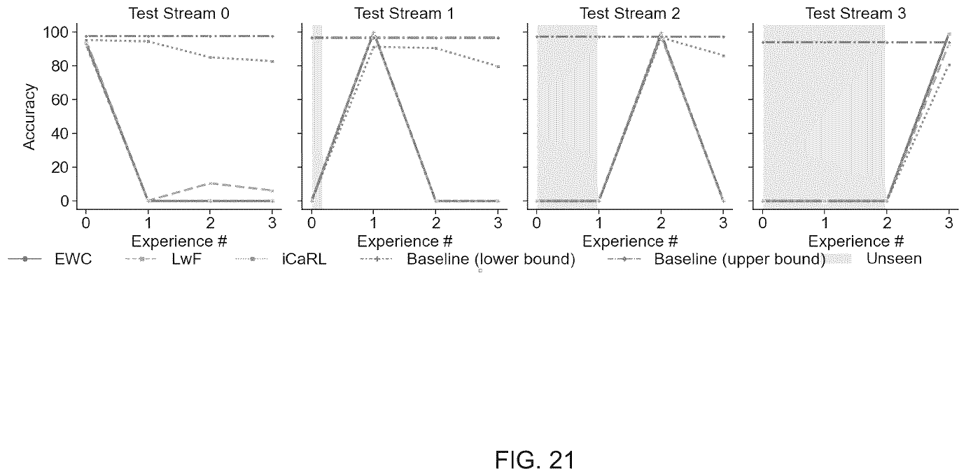

Class incremental scenario: iCaRL performed significantly better than the other methods. None of the tested methods including the lower bound baseline was able to retain knowledge about classes learnt in previous experiences. iCaRL performed at an overall accuracy of 88% which is ˜6% lower than joint training upper bound. It is still beneficial considering the lesser load on data storage and resources. FIG. 21 shows 4 class incremental experiences tested with different CL methods as listed in the legend including two baselines. Each experience comprised of its own test stream containing examples from classes belonging exclusively to the experience. Each subplot shows how the model performed on a test stream evaluated at the end of training on all experiences. The grayed-out regions show the experiences the model has not yet been trained out-the model is expected to perform poorly on these experiences. However, once the model has been trained on a particular experience, it should ideally not forget what it has learnt and retain the knowledge through the rest of the training process-that is, accuracy should remain high in the non-grayed out region for all test streams. It can be seen that iCaRL is the only CL method that performs well on the current experience and does not completely forget previous knowledge. Experience 0, which the model is first trained on, is the most forgotten experience with an accuracy of 64% at the end of the training process.

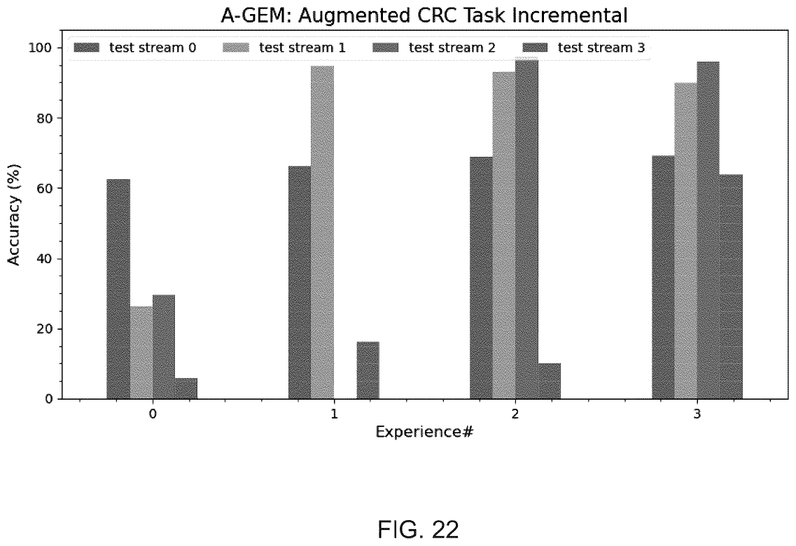

Few-shot online continual learning: The biggest gains with both CoPE and A-GEM comes with the amount of training data with each experience. A-GEM was tested with a class incremental setup with task ID's, where model update was based on only 128 randomly chosen examples stored in memory with 1 epoch while producing comparable results to iCaRL which is not an online method and was trained over 15 epochs. The overall accuracy at the end of training was at 79%, over 50% better than the lower bound baseline. Detailed results are in FIG. 22—The dataset was initially designed as a class incremental scenario with each experience assigned a separate task ID and trained on a multi-headed architecture in an online fashion. Overall accuracy was at ˜79% with the baseline lower bound at 27%. A-GEM also performs significantly worse when used without task IDs. A-GEM was not able to retain any of the previous knowledge gained.

CoPE was tested in a domain incremental scenario, where the dataset was divided into mini experiences, each with the same number of examples as the mini batch size to simulate online training. It had an overall accuracy of 67%-11% better than the lower bound baseline. It is interesting to compare results from COPE with LwF and EWC results from domain incremental scenario. With both of the latter methods, the model did not perform well on test streams. from domains 1 and 2. While CoPE did not help retain knowledge from domain 1 (accuracies of <25%), the model had an accuracy of 60% from domain 2. It is possible that the online setup helped retain more information. CoPE was also found to be sensitive to the softmax temperature. As opposed to using a temperature of >1 as in other distillation methods, temperatures lower than for a harder softmax distribution were tested on as recommended in the literature. A finer sweep of the hyperparameter might yield better results. Another point to keep in mind is how each experience is split into mini batches or mini experiences in CoPE. Each experience in the tested setting had 128 samples or examples. Not all classes are equally represented in each of the mini experiences which could also impact overall accuracy.

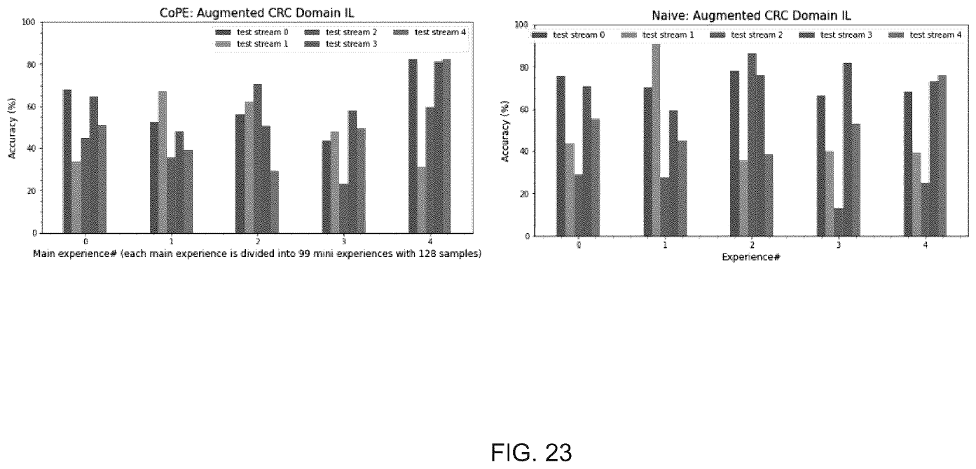

Comparison between CoPE and baseline is shown in FIG. 23. Experiences were split with a user-defined size of 128 images resulting in 99 mini-experiences within each experience which were fed to the model in an online fashion. The numbers shown in the left plot are at the end of every 99th mini experience or every main experience. On the right are the results from fine tuning/naive baseline. Equal representation from all synthetic domains in each experience resulted in transfer learning and test streams benefiting from all of the data for both CoPE as well as baseline but overall accuracy was better with CoPE.

The impact of class grouping on continual learning

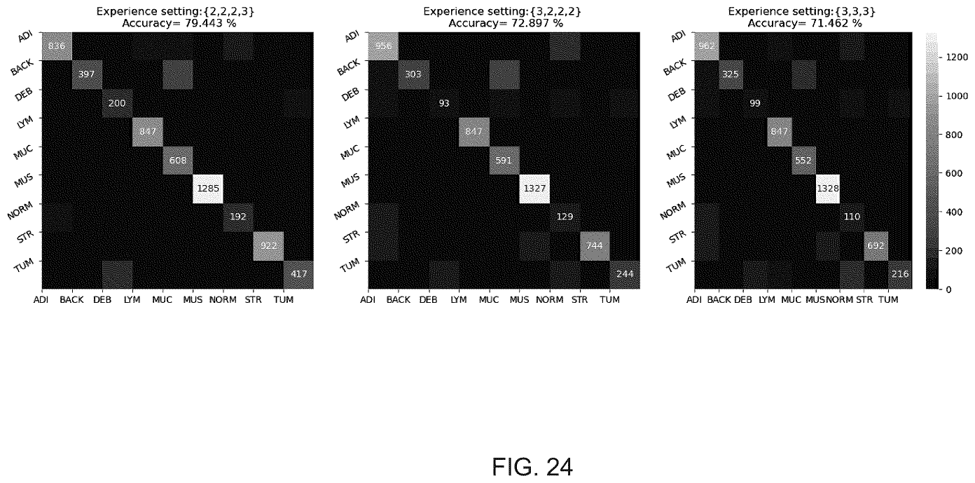

Results from the third experiment with different class grouping settings are shown in FIG. 24. Three settings were tested: A. 4 experiences with 2 classes in the first three and 3 classes in the last; B. 4 experiences with 3 classes in the first experience and 2 classes in the remaining experiences; C. 3 experiences with 3 classes each. Comparing the first two subplots, both of which had 4 experiences, there is a drop in overall accuracy of ˜6.5%. The difference between the two settings is how many classes the model was trained on in the first experience. The hypothesis here is based on curriculum learning that knowledge is better captured if harder tasks follow easier tasks. Here, starting off with three classes might be harder for the model to learn and retain knowledge which is reflected in the drop in accuracy despite the rest of the experiences trained on just two classes each in both settings. The same hypothesis can be applied to the third setting as well. Despite having fewer experiences, the model has more to learn in each experience—3 classes vs 2 classes in setting 1—in turn causing a drop of nearly 8% in accuracy.

Continually Learning from Multiple Tumor Types

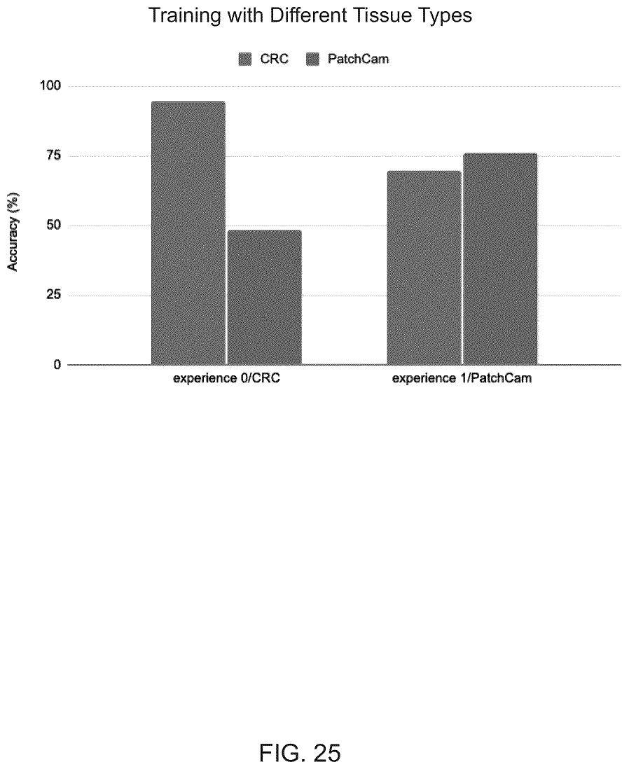

Both EWC and LwF were evaluated with this experiment and LwF produced slightly better results which are presented in FIG. 25. CRC was designed to be the first domain and PatchCam to be the second. The model started off well with over 90% accuracy on the CRC test stream but at the end of training, it did forget some of the knowledge acquired in the first experience. At the end of the training process, the model produced an accuracy of ˜70% on the CRC test stream and ˜76% on the PatchCam test stream.

### CONCLUSION

This systematic study characterized the performance of various continual learning methods for different scenarios with augmented digital pathology images and evaluated the models when they were presented with different tumor types. The datasets were evaluated on regularization and replay methods. Though EWC and LwF performed relatively well in data and domain incremental scenarios, the rehearsal methods, iCaRL and A-GEM, were needed to prevent catastrophic forgetting in the more challenging class incremental scenario. The few shot, online methods tested require additional fine tuning of hyperparameters and experimental setup to fully understand their effectiveness. Additionally, it was interesting to investigate how the changes in the images from a clinical perspective with shifted patient population, disease progression and/or disease (sub) type impact the performance of these CL methods, which provides insights into the feasibility of applying these methods in the clinical setting. In these experiments, it was discovered that knowledge pertaining to stain intensity was difficult to retain whereas the models seemed less sensitive to hue changes within the ranges tested. Though some of the results demonstrate difficulty in learning tumor classification from DP images, this study shows the potential of continuous learning in adapting to changes in clinical histopathological image acquisition factors.

### VIII. Additional Considerations

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

The ensuing description provides preferred exemplary embodiments only, and is not intended to limit the scope, applicability or configuration of the disclosure. Rather, the ensuing description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

What is claimed is:

1. A computer-implemented method comprising:
obtaining, at a data processing system, a first annotated training set of images for training a machine learning algorithm to detect, characterize, classify, or a combination thereof some or all regions or objects within the images, wherein the first annotated training set of images are in a first image domain;
splitting, by the data processing system, the first annotated training set of images into mini-sets of images each mini-set representing a distinct modeling subtask and comprising a limited number of examples;
training, by the data processing system, the machine learning algorithm in a first phase using the mini-sets of images to generate a preconditioned machine learning model configured to detect, characterize, classify, or a combination thereof some or all regions or objects within new images;
label, by the data processing system, a limited number of images from a target dataset to generate a second annotated training set of images for training a machine learning algorithm to detect, characterize, classify, or a combination thereof some or all regions or objects within the images, wherein the second annotated training set of images are in a second image domain; and
training, by the data processing system, the preconditioned machine learning model in a second phase using the second annotated training set of images to generate a target machine learning model configured to detect, characterize, classify, or a combination thereof some or all regions or objects within the new images, wherein a number of classes being trained on in the first phase are a part of or match the number of classes being trained on in the second phase.

2. The computer-implemented method of claim 1, wherein the first annotated training set of images are digital pathology images comprising one or more types of cells.

3. The computer-implemented method of claim 1, wherein the splitting comprises:
when only one mini-set of images is available, for each distinct modeling subtask, select a subset of classes to be a part of or match the number of classes being trained on in the second phase and select the limited number of examples based on the selected subset of classes; and
when multiple mini-sets of images are available, for each distinct modeling subtask, either: (i) mix examples from the multiple mini-set of images, select a subset of classes to be a part of or match the number of classes being trained on in the second phase, and select the limited number of examples from the mixed examples based on the selected subset of classes, or (ii) select a mini-set of images from the multiple mini-set of images, select a subset of classes to be a part of or match the number of classes being trained on in the second phase, and select the limited number of examples from the selected mini-set of images based on the selected subset of classes.

4. The computer-implemented method of claim 1, wherein the second phase further comprises:
applying the preconditioned machine learning model to generate a feature vector representation for each example within the second annotated training set of images;
combining the feature vector representations from examples of a same class to generate one representation per target class, use one representation per target class as prototypes for target classes;
generating feature vector representations for images or image regions of a remainder of unlabeled images from the target dataset; and
comparing each feature vector representation from the unlabeled images with the prototypes for target classes based on a distance between the feature vector representation from the unlabeled images and the prototypes for target classes.

5. The computer-implemented method of claim 1, wherein the first phase further comprises:
an inner learning-loop, wherein the machine learning algorithm updates model weights or parameters on one subtask with a predefined or flexible number of epochs for initializing the preconditioned machine learning model for adaption to the target dataset, which generates a loss for a validation set of images after model update, denoted as L-subtask-i for an ith-subtask; and
an outer learning-loop, wherein an objective is to search for a set of model initializations that generates the preconditioned machine learning model when used for updating all subtasks, each with only the limited number of examples, by finding a model initialization that minimizes a sum of all loss, denoted as summing up L-subtask-i, with i ranging from 1 to a number of subtasks calculated from validation sets of images of the subtasks with respect to the model initialization.

6. The computer-implemented method of claim 1, wherein the training of the first phase comprises performing iterative operations to learn a set of parameters to detect, characterize, classify, or a combination thereof some or all regions or objects within the mini-sets of images that maximizes or minimizes a cost function, wherein each iteration involves finding the set of parameters for the machine learning algorithm so that a value of the cost function using the set of parameters is larger or smaller than a value of the cost function using another set of parameters in a previous iteration, and wherein the cost function is constructed to measure a difference between predictions made for some or all the regions or the objects using the machine learning algorithm and ground truth labels provided for the mini-sets of images.

7. The computer-implemented method of claim 1, wherein the training of the second phase comprises performing iterative operations to learn a set of parameters to detect, characterize, classify, or a combination thereof some or all regions or objects within the second annotated training set of images that maximizes or minimizes a cost function, wherein each iteration involves finding the set of parameters for the preconditioned machine learning model so that a value of the cost function using the set of parameters is larger or smaller than a value of the cost function using another set of parameters in a previous iteration, and wherein the cost function is constructed to measure a difference between predictions made for some or all the regions or the objects using the preconditioned machine learning model and ground truth labels provided for the second annotated training set of images.

8. The computer-implemented method of any one of claims 1, further comprising:
identifying a digital pathology scenario;
selecting an adaptive continual learning method for updating the target machine learning model given the digital pathology scenario; and
updating the target machine learning model based on the adaptive continual learning method to generate an updated machine learning model.

9. The computer-implemented method of claim 8, wherein the digital pathology scenario is a data incremental scenario, a domain incremental scenario, class incremental scenario, or a task incremental scenario.

10. The computer-implemented method of claim 8, wherein the adaptive continual learning method is selected from the group comprising: Elastic Weight Consolidation (EWC), Learning without Forgetting (LWF), Incremental Learner and Representation Learning (iCaRL), Continual Prototype Evaluation (CoPE), A-GEM, and a parameter isolation method.

11. The computer-implemented method of claim 1, further comprising providing the target machine learning model and/or the updated machine learning model.

12. The computer-implemented method of claim 11, wherein the providing comprises deploying the target machine learning model and/or the updated machine learning model in a digital pathology system.

13. The computer-implemented method of claim 1, further comprising:
receiving, by the data processing system, a new image;
inputting the new image into the target machine learning model or the updated machine learning model;
detecting, characterizing, classifying, or a combination thereof, by the target machine learning model or the updated machine learning model, some or all regions or objects within the new images; and
outputting, by the target machine learning model or the updated machine learning model, an inference based on the detecting, characterizing, classifying, or a combination thereof.

14. The computer-implemented method of claim 13, further comprising:
determining, by a user, a diagnosis of a subject associated with the new image, wherein the diagnosis is determined based on the inference output by the target machine learning model or the updated machine learning model.

15. The computer-implemented method of claim 14, further comprising:
administering, by the user, a treatment to the subject based on (i) inference output by the target machine learning model or the updated machine learning model, and/or (ii) the diagnosis of the subject.

16. The computer-implemented method of claim 1, wherein the training the machine learning algorithm comprises implementing meta-learning principles to enable the first phase to use the limited number of examples to generate the preconditioned machine learning model.

17. The computer-implemented method of claim 1, wherein the training the preconditioned machine learning model comprises implementing meta-learning principles to enable the second phase to use the limited number of images to generate the target machine learning model.

18. A system comprising:
one or more data processors; and
a non-transitory computer readable storage medium containing instructions which, when executed on the one or more data processors, cause the one or more data processors to perform operations comprising:
obtaining a first annotated training set of images for training a machine learning algorithm to detect, characterize, classify, or a combination thereof some or all regions or objects within the images, wherein the first annotated training set of images are in a first image domain;
splitting the first annotated training set of images into mini-sets of images each mini-set representing a distinct modeling subtask and comprising a limited number of examples;
training the machine learning algorithm in a first phase using the mini-sets of images to generate a preconditioned machine learning model configured to detect, characterize, classify, or a combination thereof some or all regions or objects within new images;
label a limited number of images from a target dataset to generate a second annotated training set of images for training a machine learning algorithm to detect, characterize, classify, or a combination thereof some or all regions or objects within the images, wherein the second annotated training set of images are in a second image domain; and
training the preconditioned machine learning model in a second phase using the second annotated training set of images to generate a target machine learning model configured to detect, characterize, classify, or a combination thereof some or all regions or objects within the new images, wherein a number of classes being trained on in the first phase are a part of or match the number of classes being trained on in the second phase.

19. A computer-program product tangibly embodied in a non-transitory machine-readable storage medium, including instructions configured to cause one or more data processors to perform operations comprising:
obtaining a first annotated training set of images for training a machine learning algorithm to detect, characterize, classify, or a combination thereof some or all regions or objects within the images, wherein the first annotated training set of images are in a first image domain;
splitting the first annotated training set of images into mini-sets of images each mini-set representing a distinct modeling subtask and comprising a limited number of examples;
training the machine learning algorithm in a first phase using the mini-sets of images to generate a preconditioned machine learning model configured to detect, characterize, classify, or a combination thereof some or all regions or objects within new images;
label a limited number of images from a target dataset to generate a second annotated training set of images for training a machine learning algorithm to detect, characterize, classify, or a combination thereof some or all regions or objects within the images, wherein the second annotated training set of images are in a second image domain; and
training the preconditioned machine learning model in a second phase using the second annotated training set of images to generate a target machine learning model configured to detect, characterize, classify, or a combination thereof some or all regions or objects within the new images, wherein a number of classes being trained on in the first phase are a part of or match the number of classes being trained on in the second phase.
